(19) United States
(12) Patent Application Publication
(10) Pub. No.: US 2006/0260898 A1
(43) Pub. Date: Nov. 23, 2006

(54) Flywheel assembly

(75) Inventors: Hiroyoshi Tsuruta, Hirakata-shi (JP); Hiroshi Uehara, Osaka (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation, Neyagawa-shi (JP)

(21) Appl. No.: 11/488,643

(22) Filed: Jul. 19, 2006

Related U.S. Application Data
(63) Continuation-in-part of application No. PCT/JP05/00672, filed on Jan. 20, 2005.

(30) Foreign Application Priority Data
Jan. 26, 2004 (JP) JP 2004-017472

(51) Int. Cl. F16F 15/30

(52) U.S. Cl. 192/55.1

(57) ABSTRACT

A flywheel assembly to which a torque is input from the crankshaft of the engine, has a flywheel, a damper mechanism to connect elastically the flywheel to the crankshaft in the rotational direction, and a slip clutch to transmit torque from the damper mechanism to the flywheel and to slip in response to torque that exceeds a predetermined value.

### BACKGROUND OF THE INVENTION

1. Field of the Invention

The invention relates to a flywheel assembly. More specifically, the present invention relates to a flywheel assembly in which a flywheel is connected to the crankshaft through a damper mechanism to transmit torque therebetween.

2. Background Information

Conventionally, a flywheel is attached to a crankshaft of an engine for absorbing vibrations caused by variations in engine combustion. Further, a clutch device is arranged on a transmission side (i.e., in a position axially shifted toward the transmission) with respect to the flywheel. The clutch device usually includes a clutch disk assembly coupled to an input shaft of the transmission, and a clutch cover assembly for biasing the frictional coupling portion of the clutch disk assembly toward the flywheel. The clutch disk assembly typically has a damper mechanism for absorbing and damping torsional vibrations. The damper mechanism has elastic members such as coil springs arranged to compress in a rotating direction.

A structure is also known in which the damper mechanism is not arranged in the clutch disk assembly, and rather is arranged between the flywheel and the crankshaft. In this structure, the flywheel is located on the output side of a vibrating system, in which the coil springs form a border between the output and input sides, so that inertia on the output side is larger than that in other prior art. Consequently, the resonance rotation speed can be lower than an idling rotation speed so that damping performance is improved. The structure, in which the flywheel and the damper mechanism are combined as described above, provides a flywheel assembly or a dual mass flywheel was shown in Japanese Unexamined Patent Publication H04-231757, which is hereby incorporated herein by reference. The flywheel fixed to the crankshaft of the engine is called a first flywheel, and the flywheel connected to the crankshaft via the elastic members is called a second flywheel.

The damper mechanism used in the dual mass flywheel has an input member, an output member, and a plurality of elastic members for elastically connecting both members. The input member is a disk-like member formed with a plurality of window holes for accommodating the elastic members. The output member is composed of a pair of disk-like members disposed axially on the opposite sides of the input member. The friction resistance generation mechanism generates friction resistance when the input member and the output member rotate relative to each other to compress the elastic members in the rotational direction. The friction resistance generation mechanism has a plurality of washers disposed axially between the radially inner portions of the input member and the output member. For example, the friction resistance generation mechanism has a friction washer contacting input member, a friction plate engaging with the output member, and an urging member elastically compressed between the output member and the friction plate to urge both members.

When a large torque is inputted into the dual mass flywheel, the toque from the dual mass flywheel is transmitted to the damper mechanism and the damper mechanism is destroyed. So, in general, friction resistance generated in the friction resistance mechanism is set to a large value to restrict operation of the damper mechanism. However, it is difficult to dampen the shock of some torque for some driving patterns by the friction of the friction resistance mechanism such that the possibility of destroying the damper mechanism is obviated.

In view of the above, it will be apparent to those skilled in the art from this disclosure that there exists a need for an improved flywheel assembly. This invention addresses this need in the art as well as other needs, which will become apparent to those skilled in the art from this disclosure.

### SUMMARY OF THE INVENTION

It is an object of the present invention to restrict operation of the damper mechanism of the flywheel assembly when shock torque, i.e., excessive torque, is inputted in order to prevent the destruction of the damper mechanism.

According to a first aspect of the present invention, a flywheel assembly to which a torque is input from the crankshaft of the engine, has a flywheel, a damper mechanism that elastically connects the flywheel to the crankshaft in the rotational direction, and a slip clutch that transmits torque from the damper mechanism to the flywheel and to slip in response to torque that exceeds a predetermined value.

In this flywheel assembly, torque from the crankshaft is transmitted to the flywheel through the damper mechanism. When the flywheel rotates relative to the crankshaft by torque variations due to fluctuation of engine combustion, the damper mechanism operates in the rotational direction between an input member and an output member to dampen torsional vibration quickly.

When shock torque is input from the damper mechanism to the flywheel, the slip clutch slips such that a large amount of torque is not applied to the damper mechanism. For example, if the slip clutch is set to operate, i.e., to slip, when a torque that is smaller than the torque capacity of the damper mechanism is inputted, torque that exceeds torque capacity is never input to the damper mechanism. Thus, the damper mechanism is protected from destruction by shock torque.

A flywheel assembly according to a second aspect of the present invention is the assembly of the first aspect, wherein the slip clutch is preferably disposed in a radially outward portion of the flywheel. Accordingly, it is possible to increase the torque value at which the slip clutch operates.

A flywheel assembly according to a third aspect of the present invention is the assembly of the second aspect, wherein the slip clutch is preferably disposed radially outward of a clutch friction surface of the flywheel. Accordingly, it is possible to increase the torque value at which the slip clutch operates.

A flywheel assembly according to a fourth aspect of the present invention is the assembly of any of the first to third aspects, wherein, the slip clutch preferably has a plate portion which is a part of an output member of the damper mechanism, and an elastic member urging the plate portion against the flywheel. In this flywheel assembly, the slip clutch is composed two members and a part of the flywheel is utilized as a friction surface, thereby realizing a simple structure.

A flywheel assembly according to a firth aspect of the present invention is the assembly of the fourth aspect, wherein, the plate portion is preferably in contact with both axial side surfaces of the flywheel. Accordingly, it is possible to increase the torque value at which the slip clutch operates.

A flywheel assembly according to a sixth aspect of the present invention is the assembly of the fourth or fifth aspect, wherein, the elastic member is preferably fixed to the plate member.

A flywheel assembly according to a seventh aspect of the present invention is the assembly of the sixth aspect, wherein, the plate member preferably has a first plate in contact with an axially engine side of the flywheel, and a second plate engaged with the first plate to move in the axial direction relatively to the first plate and not to move in the rotational direction relatively to the first plate. The second plate is in contact with an axially opposite surface of the flywheel. The elastic member urges the second plate against the axially opposite surface of the flywheel. Accordingly, the first plate and the second plate of the plate member slide against the flywheel such that it is possible to increase the torque value at which the slip clutch operates.

A flywheel assembly according to an eighth aspect of the present invention is the assembly of the fourth aspect, wherein, the elastic member is preferably fixed to the flywheel.

A flywheel assembly according to a ninth aspect of the present invention is the assembly of the first aspect that further includes a plurality of fixing members arranged in the circumferential direction to fix the damper mechanism to the crankshaft. The flywheel has a flywheel main body to which the slip clutch is connected, and a positioning member to position the flywheel main body in the radial direction relative to a member on the crankshaft side. The positioning member is rotatable relative to the flywheel main body. The positioning member is formed with a plurality of axially through holes corresponding to the fixing members.

In this flywheel assembly, the flywheel is divided into the flywheel main body and the positioning member. Further, the flywheel main body rotates relative to the damper mechanism and the positioning member when the slip clutch operates. The positioning member does not rotate together with the flywheel main body so that the axially through holes are not displaced from the fixing members in the rotational direction. Consequently, even if the slip clutch operates, it is possible to operate fixing members as they are, that is, it is possible to remove the flywheel assembly from the crankshaft easily.

A flywheel assembly in accordance with a tenth aspect of the present invention is the assembly of the ninth aspect, wherein, the positioning member is preferably engaged with an output member of the damper mechanism not to rotate relatively. When the flywheel main body rotates relative to the damper mechanism and the positioning member, the positioning member rotates together with the output member of the damper so that the axially through holes are not displaced from the fixing members in the rotational direction. Consequently, even if the slip clutch operates, it is possible to operate fixing members as they are, that is, it is possible to remove the flywheel assembly from the crankshaft easily.

A flywheel assembly in accordance with an eleventh aspect of the present invention is the assembly of the tenth aspect, wherein, the positioning member is preferably engaged with the output member to move relatively in the axial direction. Accordingly, when an axial load is applied to the positioning member from the flywheel main body, the positioning member moves relative to the output member.

A flywheel assembly in accordance with a twelfth aspect of the present invention is the assembly of the tenth or eleventh aspect, that further includes a friction generation mechanism disposed between an input member of the damper mechanism and the positioning member. Accordingly, when the damper mechanism operates, the input member and the positioning member rotate relative to each other and the friction generation mechanism generates friction.

A flywheel assembly in accordance with a thirteenth aspect of the present invention is the assembly of any of the ninth to twelfth aspects, wherein, the positioning member preferably transmits an axial load from the flywheel main body to the member on the crankshaft side. Accordingly, when an axial load is applied to the positioning member from the flywheel main body, the positioning member is received by the member on the crankshaft side. The member on the crankshaft side is a crankshaft or a member fixed to the crankshaft not to rotate relatively to the crankshaft.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of a dual mass flywheel assembly in accordance with a preferred embodiment of the present invention;

FIG. 2 is an alternate schematic cross-sectional view of the dual mass flywheel assembly;

FIG. 3 is an enlarged fragmentary elevational view of the dual mass flywheel assembly with sections removed for illustrative purposes;

FIG. 4 is an alternate enlarged fragmentary plain view of the dual mass flywheel assembly;

FIG. 5 is an enlarged fragmentary cross-sectional view that particularly illustrates a second frictional resistance generating mechanism of the dual mass flywheel assembly;

FIG. 6 is an elevational view of the second friction generation mechanism;

FIG. 7 is an enlarged elevational view of the second friction generation mechanism;

FIG. 8 is an enlarged cross-sectional view of a first friction generation mechanism of the dual mass flywheel assembly;

FIG. 9 is an enlarged cross-sectional view of the first friction generation mechanism;

FIG. 10 is an enlarged elevational view of the first friction generation mechanism;

FIG. 11 is an elevational view of a first friction washer of the first friction generation mechanism;

FIG. 12 is an elevational view of an input disk-like plate of a damper mechanism of the dual mass flywheel assembly;

FIG. 13 is an elevational view of a washer of the first friction generation mechanism;

FIG. 14 is an elevational view of a cone spring of the first friction generation mechanism;

FIG. 15 is an elevational view of a second friction washer of the first friction generation mechanism;

FIG. 16 is a view of a mechanical circuit diagram of a damper mechanism and the friction and second generation mechanisms of the dual mass flywheel assembly;

FIG. 17 is an elevational view that illustrates the operation of the second friction resistance generation mechanism;

FIG. 18 is an elevational view that illustrates the operation of the second friction resistance generation mechanism;

FIG. 19 is an elevational view that illustrates operation of the second friction resistance generation mechanism;

FIG. 20 is a view of a diagram of torsional characteristics of the damper mechanism and the friction generation mechanisms;

FIG. 21 is an enlarged fragmentary view of a diagram of torsional characteristics of the damper mechanism and the friction generation mechanisms;

FIG. 22 is a fragmentary cross sectional view that illustrates the operation of the second friction resistance generation mechanism during a clutch release operation.

FIG. 23 is an elevational view that illustrates a relationship between a positioning member and a crankshaft of the dual mass flywheel assembly;

FIG. 24 is a view of a diagram of torsional characteristics of a damper mechanism and friction generation mechanisms of a dual mass flywheel assembly in accordance with a second and third preferred embodiment of the present invention showing a clutch release;

FIG. 25 is a view of a diagram of torsional characteristics of the damper mechanism and the friction generation mechanisms of the second and third embodiments showing clutch engagement;

FIG. 26 is a schematic cross-sectional view of a slip clutch in accordance with a second preferred embodiment of the present invention; and

FIG. 27 is a schematic cross-sectional view of a slip clutch in accordance with a third preferred embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

(1) Structure

1) Overall Structure

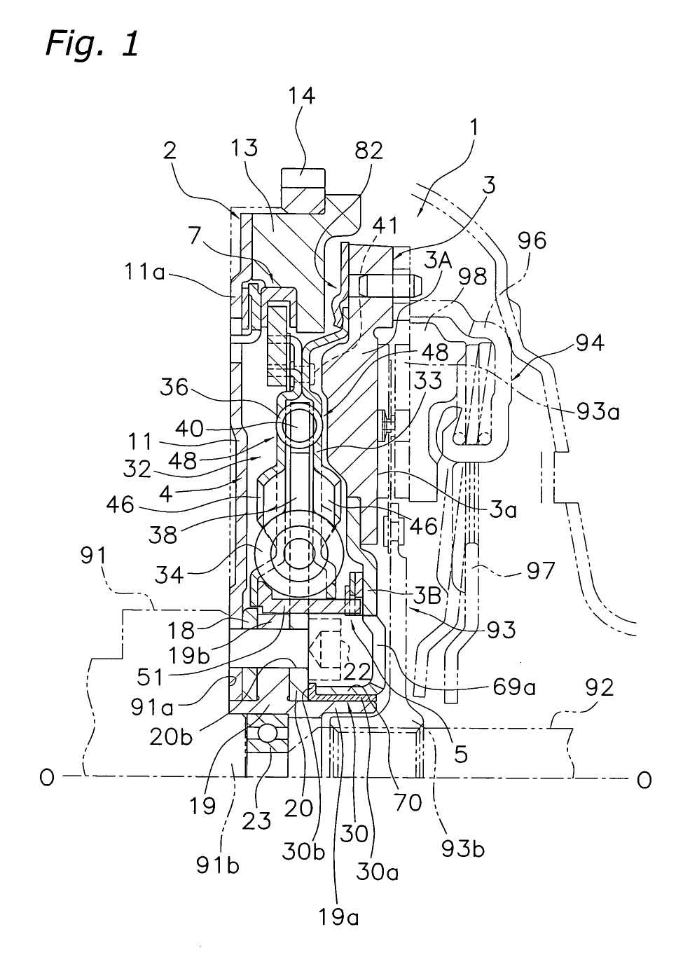

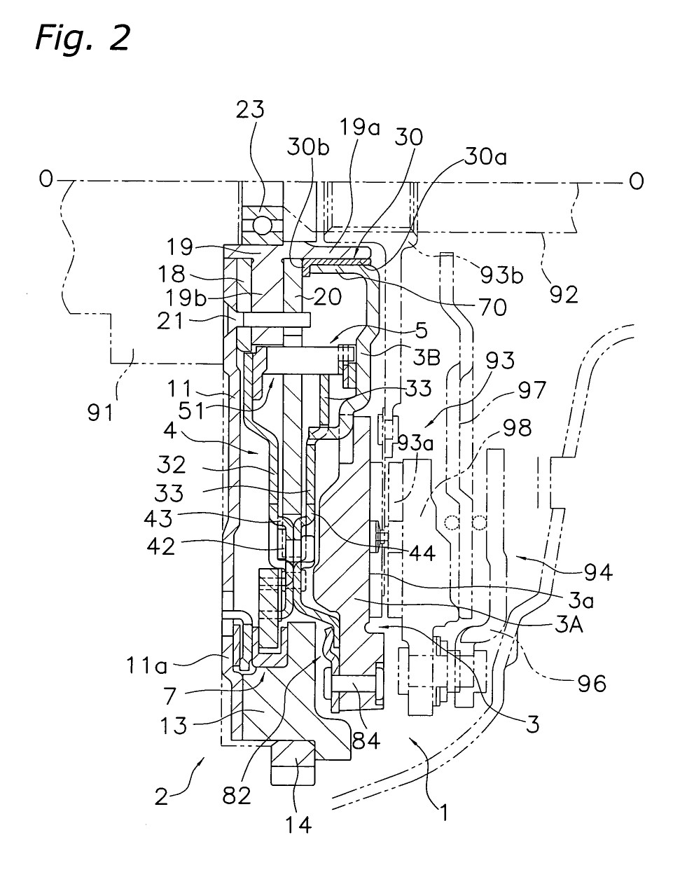

As seen in FIGS. 1 and 2, a double mass flywheel or flywheel damper 1 in accordance with a first preferred embodiment of the present invention is provided to transmit torque from a crankshaft 91 on an engine side to an input shaft 92 on an transmission side by way of a clutch including a clutch disk assembly 93 and a clutch cover assembly 94. The double mass flywheel 1 has a damper function to absorb and attenuate torsional vibration. The double mass flywheel 1 is mainly made of a first flywheel 2, a second flywheel 3, a damper mechanism 4 arranged between the flywheels 2 and 3, a first friction generation mechanism 5, and a second friction generation mechanism 7.

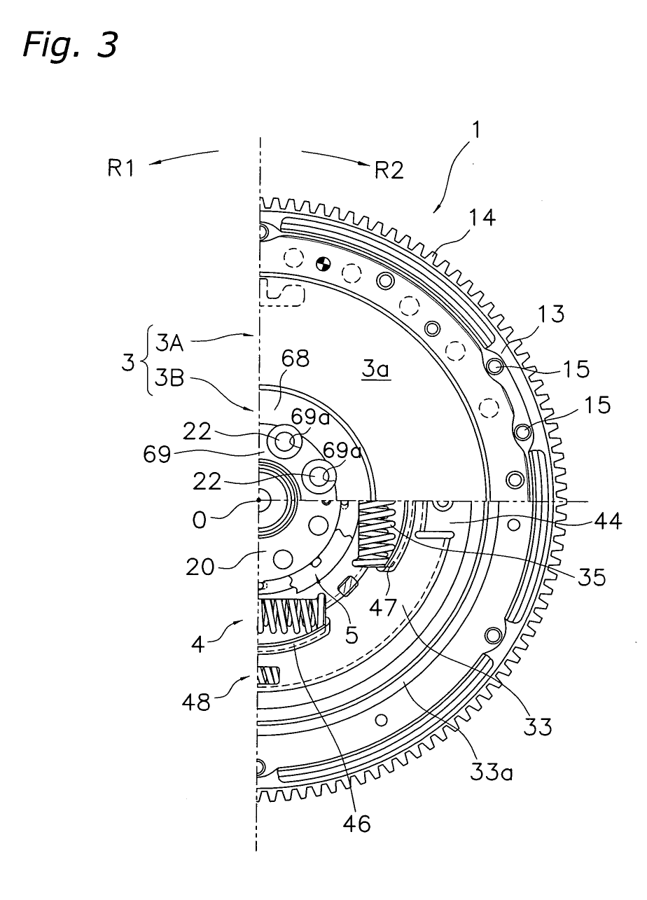

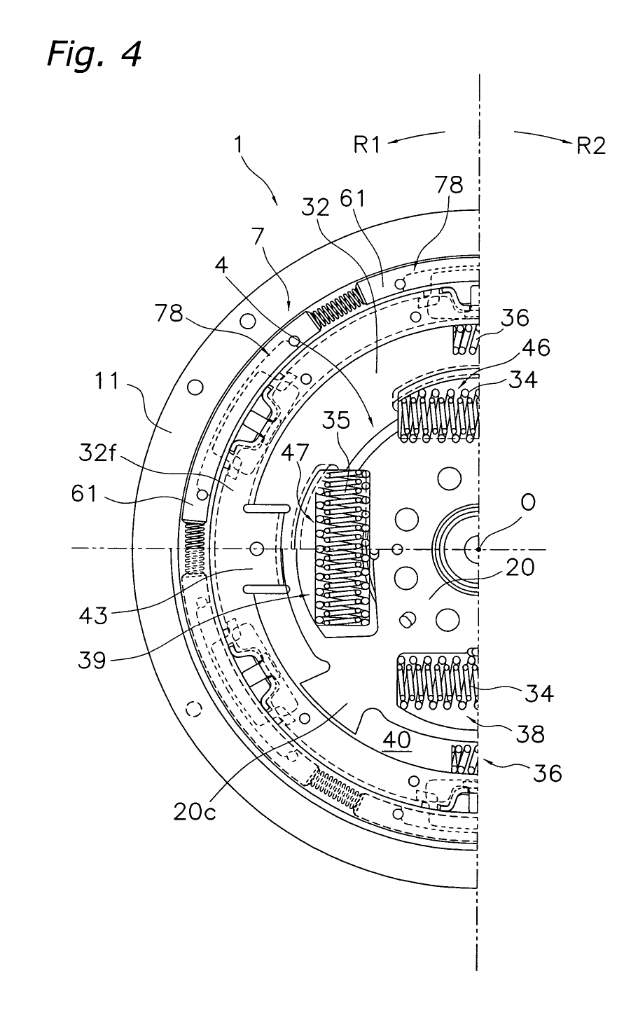

In FIGS. 1 and 2, O-O indicates a rotation axis of the double mass flywheel 1 and the clutch. An engine (not shown) is disposed on the left side in FIGS. 1 and 2, and a transmission (not shown) is disposed on the right side. In following description, the left side in FIGS. 1 and 2 will be referred to as the engine side, which is based on the axial direction, and the right side will be referred to the transmission side, which is also based on the axial direction. In FIGS. 3 and 4, an arrow R1 indicates a drive side, i.e., forward side in the rotational direction, and an arrow R2 indicates a reverse drive side (rearward side in the rotational direction).

The numerical values in the following embodiments are shown as examples and do not limit the present invention.

2) First Flywheel

The first flywheel 2 is fixed to an axial tip of the crankshaft 91. The first flywheel 2 ensures a large moment of inertia on the crankshaft 91 side. The first flywheel 2 principally includes a flexible plate 11 and an inertia member 13.

The flexible plate 11 is provided to absorb bending vibrations from the crankshaft 91 as well as to transmit torque from the crankshaft 91 to the inertia member 13. Accordingly, the flexible plate 11 has a high rigidity in the rotational direction but a relatively low rigidity in the axial and bending directions. Specifically, the axial rigidity of the flexible plate 11 is preferably equal to or below 3000 kg/mm, more preferably in a range between 600 kg/mm and 2200 kg/mm. The flexible plate 11 is a disk-like plate having a central hole and made of a metal plate, for example. The radially inner end of the flexible plate 11 is fixed to the tip of the crankshaft 91 by a plurality of bolts 22. Bolt through-holes are formed in the flexible plate 11 in positions corresponding to the bolts 22. The bolts 22 are mounted on the crankshaft 91 from the axial-direction transmission side.

The inertia member 13 is a member with a thick block shape when viewed cross-sectionally, and is fixed to the axial-direction transmission side on the radially outer edge of the flexible plate 11. The radially outer portion of the flexible plate 11 is fixed to the inertia member 13 by a plurality of rivets 15 aligned circumferentially, as shown in FIG. 3. A ring gear 14 that is provided to facilitate engine startup is fixed to the outer circumferential surface of the inertia member 13. The first flywheel 2 may also be constructed as an integral member.

3) Second Flywheel

Referring again to FIGS. 1 and 2, the second flywheel 3 is an annular disk-like member, and is disposed on the axial-direction transmission side of the first flywheel 2. The second flywheel 3 is composed of a flywheel main body 3A and a positioning member 3B to position radially or to center the flywheel main body 3A relative to a member of the crankshaft side. The flywheel main body 3A is an annular member having a thickness in the axial direction and is formed with an annular and flat clutch friction surface 3a on the transmission side in the axial direction with which a clutch disk assembly 93 is frictionally engaged.

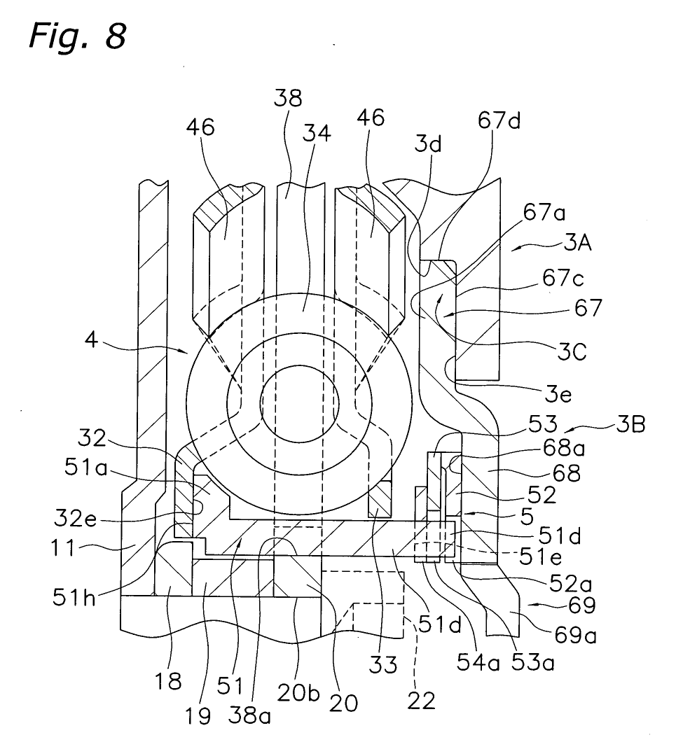

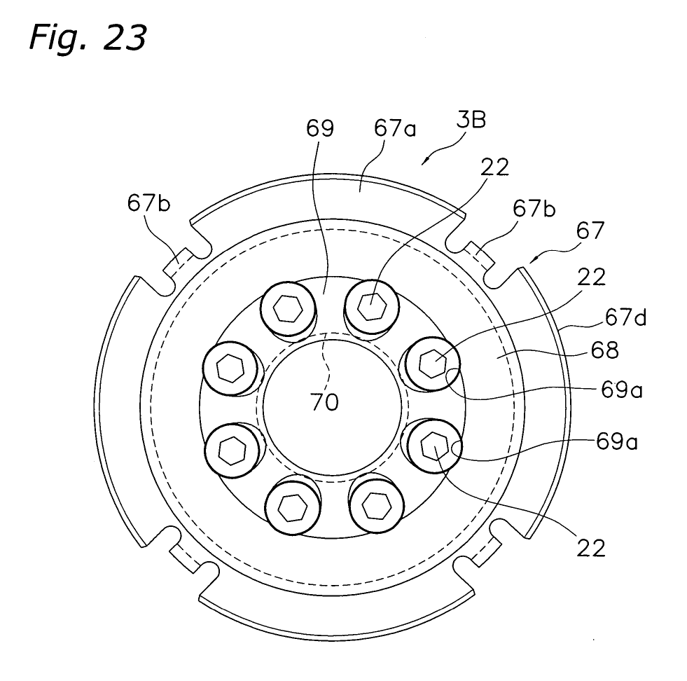

The positioning member 3B is an annular plate member made of a sheet metal located radially inward of the flywheel main body 3A. The positioning member 3B has an outer circumferential portion 67 contacting an inner circumferential portion of the flywheel main body 3A to support the flywheel main body 3A in the radial direction, as shown in FIGS. 8, 9 and 23. The outer circumferential portion 67 is made of an annular portion 67a extending generally in the circumferential direction and a plurality of engagement portions 67b dividing the annular portion 67a, as shown in FIG. 23. Referring again to FIGS. 8, 9, and 23, an outer peripheral surface 67d of the annular portion 67a is in contact with an inner peripheral surface 3d of an concave portion 3c formed at the radially inward portion of the flywheel main body 3A for relative rotation. In addition, an axial surface 67c on the transmission side of the annular portion 67a is in contact with an axial surface 3e on the engine side of the concave portion 3c. The positioning member 3B has a radially middle portion 68. The radially middle portion 68 is a generally flat portion, i.e., perpendicular to the rotational axis O-O, having an annular flat friction surface 68a on the engine side in the axial direction. Furthermore, the positioning member 3B has a radially inward portion 69 formed with a plurality of through holes 69a through which bolts 22 penetrate, as shown in FIGS. 1, 3 and 23. The through holes 69a are arranged in the circumferential direction with equal distances therebetween. The bolts 22 are located on the engine side of the through holes 69a as shown in FIG. 1. The positioning member 3B has an inner cylindrical portion 70 extending toward the engine in the axial direction from the radially inner edge.

4) Damper Mechanism

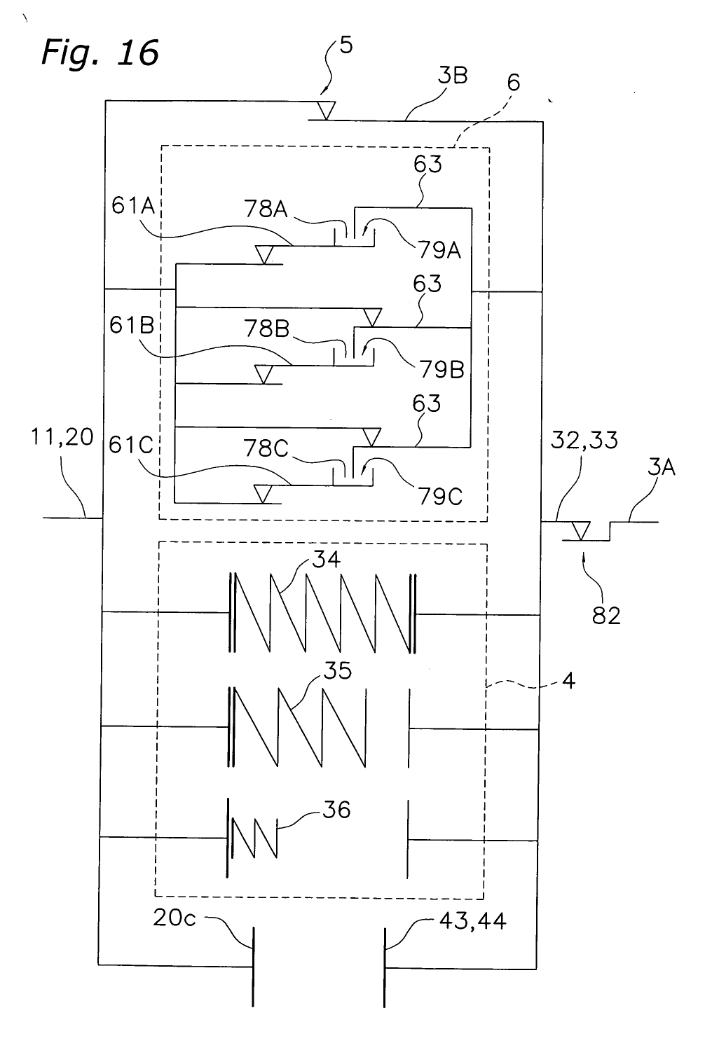

Referring to FIGS. 1, 3, and 4, the damper mechanism 4 is described below. The damper mechanism 4 elastically engages the second flywheel 3 and the crankshaft 91 in the rotational direction. Therefore, the second flywheel 3 with the damper mechanism 4 constitutes a flywheel assembly or a flywheel damper because the second flywheel 3 is connected to the crankshaft 91 by way of the damper mechanism 4. The damper mechanism 4 is composed of a plurality of coil springs 34, 35, and 36, a pair of output disk-like plates 32 and 33, and an input disk-like plate 20. As shown in the mechanical circuit of FIG. 16, the coil springs 34, 35, and 36 are located functionally in parallel with the first and second friction generation mechanism 5 and 7 in the rotational direction.

Referring again to FIGS. 1 to 4, the pair of output disk-like plates 32 and 33 is composed of a first plate 32 on the axial-direction engine side, and a second plate 33 on the axial-direction transmission side. Both plates 32 and 33 are disk-like members, and are disposed with a certain distance therebetween in the axial direction. A plurality of window portions 46 and 47 aligned in the circumferential direction is respectively formed in each of the plates 32 and 33. The window portions 46 and 47 are structures that respectively support the coil springs 34 and 35 (described hereinafter) in the axial and rotational directions, respectively hold the coil springs 34 and 35 in the axial direction, and have upwardly cut portions that make contact at both ends in the circumferential direction thereof. The number of the window portions 46 and 47 is preferably two, respectively, for a total of four. The window portions 46 and 47 are aligned alternately in the circumferential direction in the same radial position. Furthermore, the plates 32 and 33 are formed with a plurality of third window portions 48 aligned in the circumferential direction. The number of the third window portions 48 is preferably two. The third window portions 48 are opposed to each other in a radial direction. Specifically, the third window portions 48 are formed radially outward of the first window portions 46 and support the third coil springs 36 described hereinafter in the axial and rotational direction.

The first plate 32 and the second plate 33 maintain a distance in the axial direction at the radially inner portions, but are in contact with each other at the radially outer portions and fixed to each other by rivets 41 and 42. The first rivets 41 are aligned in the circumferential direction. The second rivets 42 are respectively disposed at cut and raised contact portions 43 and 44 of the first plate 32 and the second plate 33. The contact portions 43 and 44 are formed in two positions diametrically opposing each other. Specifically, the contact portions 43 and 44 are formed radially outward of the second window portion 47. As shown in FIG. 2, axial position of the contact portions 43 and 44 is the same as that of the input disk-like plate 20.

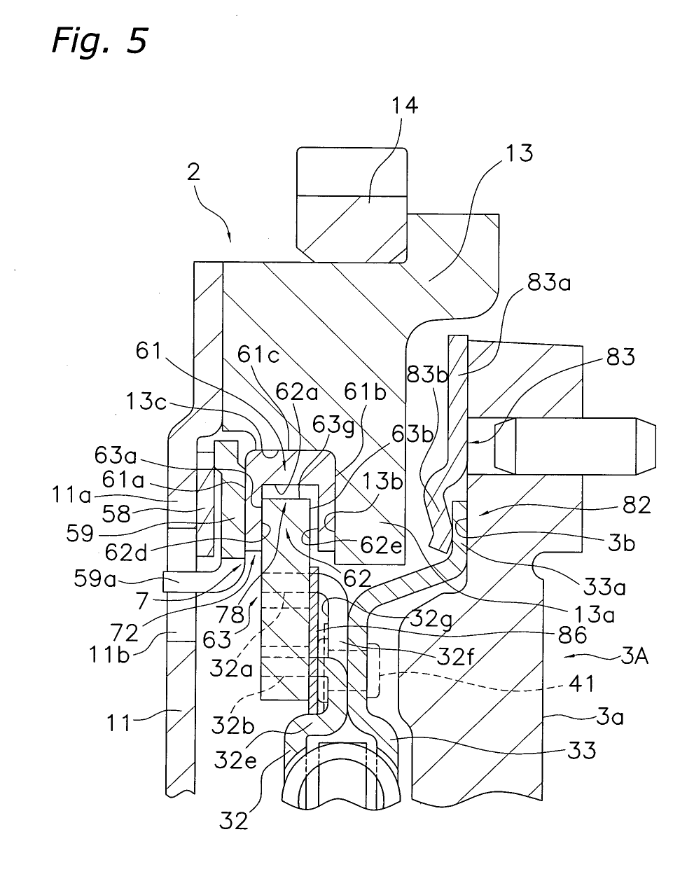

The second plate 33 is connected to the radially outward portion of the second flywheel 3 through a slip clutch 82. The slip clutch 82 slips in response to a torque of certain level or above to limit the level of the torque that is transmitted. As shown in FIG. 5, the slip clutch 82 is composed of a contact portion 33a as a radially outward portion of the second plate 33 and an elastic plate 83. The contact portion 33a is an annular and flat portion contacting a second friction surface 3b formed at the radially outward portion of the flywheel main body 3A. The second friction surface 3b is an annular flat surface formed on the transmission side in the axial direction of the radially outward portion of the flywheel main body 3A. The second friction surface 3b is located radially outward of the clutch friction surface 3a. The elastic plate 83 is an annular plate member fixed to an axial surface on the engine side in the axial direction of the radially outward portion of the flywheel main body 3A and radially outward of the second friction surface 3b with a plurality of rivets 84 (FIG. 2). The elastic plate 83 is composed of a fix portion 83a on the radially outward side and an elastically urging portion 83b on the radially inward side. The elastically urging portion 83b urges the contact portion 33a of the second plate 33 against the second friction surface 3b.

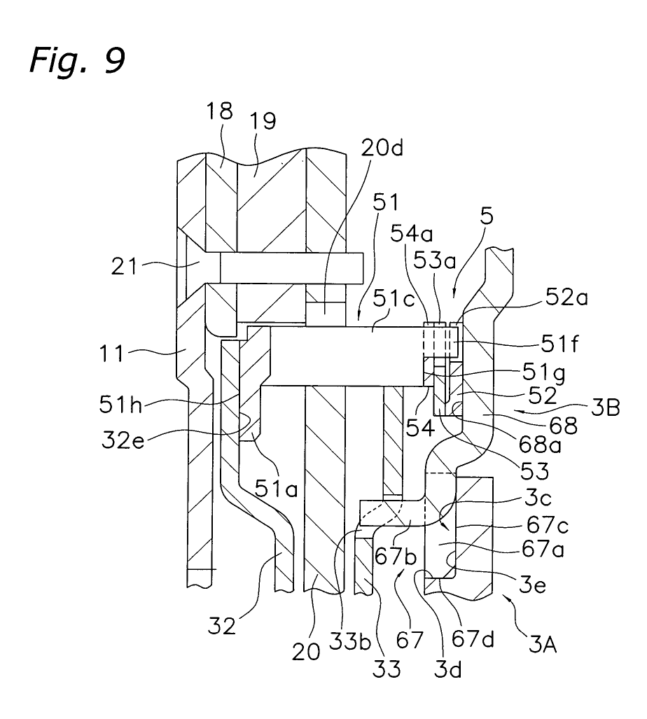

As shown, in FIG. 9, the second plate 33 is formed with cutouts 33b corresponding to the engagement portions 67b of the radially outward portion 67 of the positioning member 3B. The engagement portion 67b is inserted into the cutouts 33b, and rotational ends of the cutouts 33b and engagement portion 67b are in contact with each other. By this engagement, the positioning member 3B can move in the axial direction but not in the rotational direction relative to the output disk-like plate 33. In other words, the positioning member 3B rotates together with the output members of the damper mechanism 4 and relative to the flywheel main body 3A.

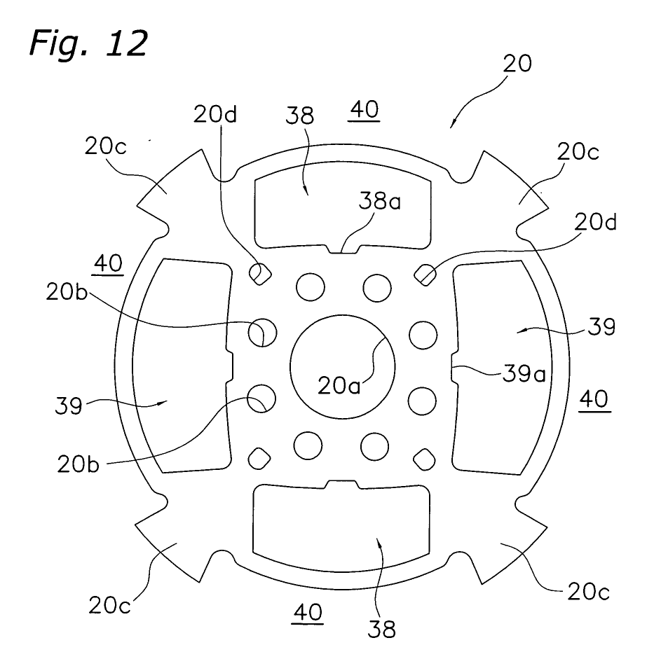

Referring to FIGS. 1, 2 and 4, the input disk-like plate 20 is a disk-like member disposed between the plates 32 and 33. The input disk-like plate 20 has a plurality of first window holes 38 corresponding to the window portions 46, and second window holes 39 corresponding to the first window portions 47. As seen in FIG. 12, the first and second window holes 38 and 39 have a straight or slightly curved radially inner edge having a recess 38a and 39a extending radially inward at the circumferentially middle portion. The input disk-like plate 20 is formed with a central hole 20a and a plurality of through holes 20b for bolts to be inserted around the central hole 20a. The input disk-like plate 20 has a plurality of protrusions 20c extending radially outward from the radially outer edge at the locations circumferentially between the window holes 38 and 39. Referring now to FIGS. 4 and 12, the protrusions 20c are positioned circumferentially apart from the contact portions 43 and 44 of the output disk-like plates 32 and 33 and the third coil springs 36 such that the protrusion 20c can collide with either of them in the circumferential direction. In other words, the protrusions 20c and the contact portions 43 and 44 constitute a stopper mechanism of the damper mechanism 4. Furthermore, spaces between the protrusions 20c in the circumferential direction function as third window holes 40 to accommodate the third coil springs 36. In addition, the input disk-like plate 20 is formed with a plurality of holes 20d. The number of holes 20d is preferably four. Each hole 20d has a shape of a circle longwise in the radial direction. More precisely, each hole 20d has a circular part on a radial outer periphery, two substantially straight parts connected to the circular part, and one substantially straight part that connects the two substantially straight parts. The parts of the hole 20d are preferably joined by rounded edges. The rotational positions of the holes 20d are between the window holes 38 and 39 in the circumferential direction, and the radial position of the holes 20d are the same as or close to those of the recesses 38a and 39a.

As seen in FIGS. 1, 2, and 12, the input disk-like plate 20 is fixed to the crankshaft 91 together with the flexible plate 11, a reinforcement member 18, and a support member 19 by the bolts 22. The radially inner portion of the flexible plate 11 is in contact with an axial transmission side surface of a tip surface 91a of the crankshaft 91. The reinforcement member 18 is a disk-like member and is in contact with an axial transmission side surface of the radially inner portion of the flexible plate 11. The support member 19 is composed of a disk-like portion 19b and a cylindrical portion 19a that extends to the axial-direction transmission side from the radially outer edge. The disk-like portion 19b is in contact with an axial transmission side surface of the reinforcement member 18. The disk-like portion 19b is formed with through holes for bolts 22 and is fixed to the crankshaft 91. The disk-like portion 19b is an annular flat portion and the cylindrical portion 19a extends toward the transmission in the axial direction from a radially inner edge. The inner circumferential surface of the cylindrical portion 19a is in contact with the outer circumferential surface of a cylindrical projection 91b formed at the center of the tip of the crankshaft 91 so that the support member 19 is centered in the radial direction. The inner circumferential surface of the input disk-like plate 20 is in contact with the outer circumferential surface of a cylindrical portion 19a at an axial transmission side portion so that the input disk-like plate 20 is centered in the radial direction. A bearing 23 is attached to the inner circumferential surface of the cylindrical portion 19a to support the tip of the input shaft 92 of the transmission. In addition, the members 11, 18, 19, and 20 are fastened to each other by screws 21.

As described above, the support member 19 is fixed to the crankshaft 91 such that the support member 19 is centered relative to the crankshaft. Further, the support member 19 centers the first flywheel 2 and the second flywheel 3 in the radial direction. That is, the one member has a plurality of functions so that the number of components is reduced and manufacturing costs are reduced.

An inner circumferential surface of the cylindrical portion 70 of the positioning member 3B is supported by an outer circumferential surface of the cylindrical portion 19a of the support member 19 through a bush 30. Accordingly, the positioning member 3B is supported in the radial direction or centered relative to the first flywheel 2 and the crankshaft 91 by the support member 19. The flywheel main body 3A is supported in the radial direction or centered relative to the first flywheel 2 and the crankshaft 91 through the positioning member 3B.

The bush 30 further has a radial bearing portion 30a already described and a thrust bearing portion 30b disposed between the radially inner portion of the input disk-like plate 20 and a tip of the cylindrical portion 70 of the positioning member 3B. As a result, a thrust load from the second flywheel 3 is received by the members 11, 18, 19, and 20, which are aligned in the axial direction through the thrust bearing portion 30b. In other words, the thrust bearing portion 30b of the bush 30 functions as a thrust bearing supported by the radially inner portion of the input disk-like plate 20 for an axial load from the second flywheel 3. The load generated at the thrust bearing portion 30b is stable because the radially inner portion of the input disk-like plate 20 is flat and the flatness is improved. Furthermore, the length of the thrust bearing portion 30b is long enough to stabilize hysteresis torque because the radially inner portion of the input disk-like plate 20 is flat. Furthermore, the radially inner portion of the input disk-like plate 20 is unlikely to be deformed since it is in direct contact with the disk-like portion 19b of the support member 19 such that there is no space in the axial direction.

Referring now to FIGS. 3 and 4, the first coil spring 34 is disposed in the first window holes 38 and the first window portions 46. Rotational ends of the first coil spring 34 are in contact with or close to rotational end surfaces of the first window holes 38 and the first window portion 46.

The second coil springs 35 are disposed in the second window holes 39 and the second window portions 47. Each second coil spring 35 is made of a large and a small spring. Thus, the second coil spring 35 has a higher rigidity than the first coil spring 34. Rotational ends of the second coil spring 35 are in contact with or close to rotational end surfaces of the second window portion 47 but are separated in the circumferential direction from rotational end surfaces of the second window hole 39 by a certain angle, which is preferably four degrees in this embodiment.

The third coil springs 36 are disposed in the third window holes 40 and the third window portions 48. The third coil springs 36 are smaller than the second and third coil springs 34 and 35. Further, the rigidity of the third coil springs 36 is higher than that of the first and second coil springs 34 and 35. The circumferential ends of the third coil springs 36 are in contact with circumferential ends of the third window portions 48 but have a large distance from circumferential ends of the third window holes 40, i.e., circumferential ends of the protrusions 20c of the input disk-like plate 20.

5) Friction Generation Mechanism

5-1) First Friction Generation Mechanism 5

The first friction generation mechanism 5 operates between the input disk-like plate 20 and the output disk-like plate 32 and 33 of the damper mechanism 4 in parallel with the coil springs 34, 35, and 36 in the rotational direction. The first friction generation mechanism 5 generates a certain frictional resistance (hysteresis torque) when the second flywheel 3 rotates relative to the crankshaft 91. The first generation mechanism 5 generates friction over the entire torsional angle region and is not excessively high.

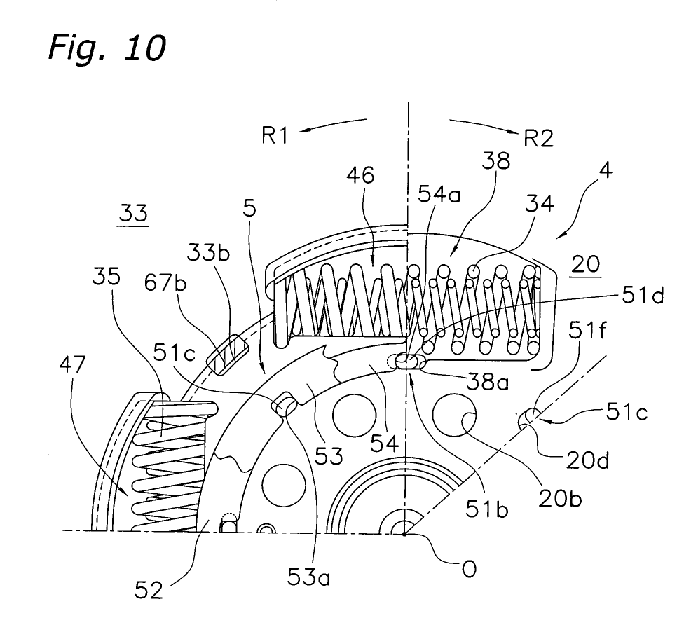

The first friction generation mechanism 5 is disposed radially inward of the damper mechanism 4 and axially between the first plate 32 and the second flywheel 3. As shown in FIGS. 8-10, the first friction generation mechanism 5 is composed of a first friction member 51, a second friction member 52, a cone spring 53, and a washer 54.

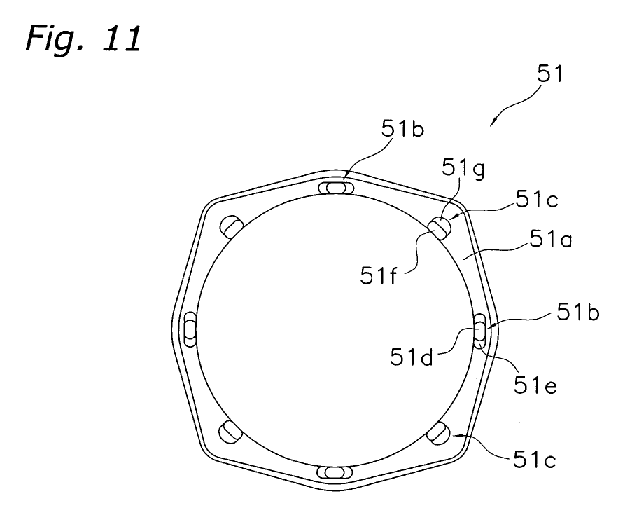

The first friction member 51 rotates together with the input disk-like plate 20 to slide against the first plate 32 in the rotational direction. As shown in FIGS. 8-11, the first friction member 51 has an annular portion 51a, and first and second engagement portions 51b and 51c extending from the annular portion 51a. An axially engine side surface 51h of the annular portion 51a contacts an axially transmission side surface 32e of the radially inner portion of the first plate 32 to slide in the rotational direction. The first engagement portions 51b and the second engagement portions 51c are located alternately in the circumferential direction. The first engagement portion 51b has a shape extending in the circumferential direction with a narrow width in the radial direction. In other words, the first engagement portion 51b is slot-shaped. The first engagement portion 51b is engaged with the recesses 38a and 39a of the window holes 38 and 39 of the input disk-like plate 20. The second engagement portion 51c has a shape extending in the radial direction and is engaged with the hole 20d of the input disk-like plate 20. Accordingly, the first friction member 51 can move relative to the input disk-like plate 20 in the axial direction, but not in the rotational direction.

A first protrusion 51d is formed at the circumferentially middle position of the tip of the first engagement portion 51b and extends in the axial direction from the first engagement portion 51b. A pair of first axial end surfaces 51e is formed on the circumferential sides of the first protrusion 51d. Furthermore, a second protrusion 51f is formed at the radially inward portion of the tip of the second engagement portion 51c. A second axial end surface 51g is formed radially outward of the second protrusion 51f.

The second friction member 52 rotates together with the input disk-like plate 20 to slide against the second flywheel 3 in the rotational direction. As shown in FIGS. 8, 9, and 15, the second friction member 52 is an annular member and contacts a flat surface 68a of the radially middle portion 68 of the positioning member 3B of the second flywheel 3 to slide in the rotational direction.

The second friction member 52 is formed with a plurality of recesses 52a aligned in the circumferential direction at the inner circumferential edge. The first protrusion 51d of the first engagement portion 51b and the second protrusion 51f of the second engagement portion 51c are respectively engaged with the recesses 52a. Accordingly, the second friction member 52 can move relative to the first friction member 51 in the axial direction, but not in the rotational direction.

The cone spring 53 is disposed axially between the first friction member 51 and the second friction member 52 and urges each of the members in axially opposite directions. As shown in FIGS. 8, 9, and 14, the cone spring 53 is a conical or disk-like member formed with a plurality of recesses 53a at the inner circumferential edge. The first protrusion 51d of the first engagement portion 51b and the second protrusion 5 if of the second engagement portion 51c are respectively engaged with the recesses 53a. Accordingly, the cone spring 53 can move relative to the first friction member 51 in the axial direction, but not in the rotational direction.

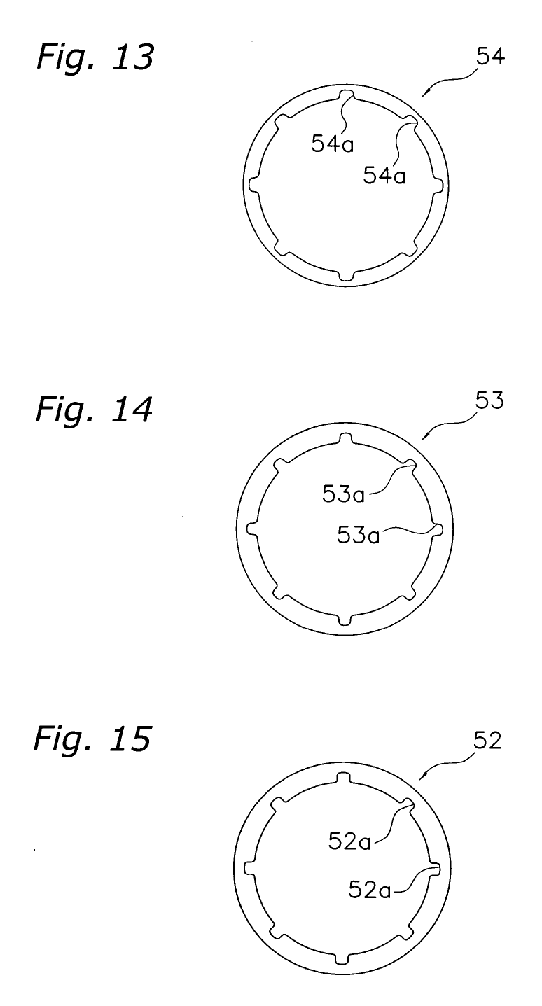

The washer 54 is provided to ensure or to stabilize the transfer of a load of the cone spring 53 to the first friction member 51. As shown in FIGS. 8, 9, and 13, the washer 54 is an annular member and is formed with a plurality of recesses 54a aligned in the circumferential direction at the radially inner edge. The first protrusion 51d of the first engagement portion 51b and the second protrusion 51f of the second engagement portion 51c are respectively engaged with the recesses 54a. Accordingly, the washer 54 can move relative to the first friction member 51 in the axial direction, but not in the rotational direction. The washer 54 is received on the first axial end surface 51e of the first engagement portion 51b and the second axial end surface 51g of the second engagement portion 51c. The radially inner portion of the cone spring 53 is supported by the washer 54 and the radially outer portion of the cone spring 53 is supported by the second friction member 52.

Accordingly, by the load of the cone spring 53, the first friction member 51 is urged against the output disk-like plate 32 and the second friction member 52 is urged against the positioning member 3B, which rotates together with the output disk-like plate 33. As a result, when the damper mechanism 4 operates, the axially engine side surface 51h of the first friction washer 51 slides relative to the axially transmission side surface 3 of the output disk-like plate 32, and the second friction washer 52 slides relative to the axially engine side surface 68a of the positioning member 3B.

5-2) Second Friction Generation Mechanism

Referring now to FIGS. 1 and 2, the second friction generation mechanism 7 operates between the input disk-like plate 20 and the output disk-like plate 32 and 33 of the damper mechanism 4 in parallel with the coil springs 34, 35, and 36. The second friction generation mechanism 7 generates a relatively large frictional resistance (hysteresis torque) over the whole range of the torsional characteristics when the second flywheel 3 rotates relative to the crankshaft 91. In this embodiment, the hysteresis torque generated by the second friction generation mechanism 7 is from five to ten times that generated by the first friction generation mechanism 5.

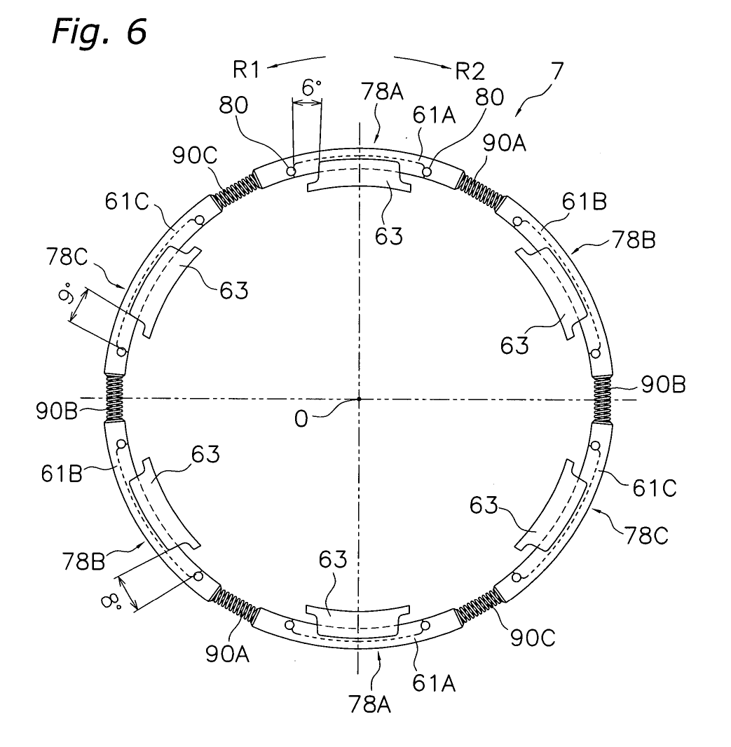

As shown in FIGS. 5 and 6, the second friction generation mechanism 7 is made of a plurality of washers contacting with each other disposed in an axial space between an annular portion 11a at the radially outer portion of the flexible plate 11 and the inertia member 13. More specifically, the inertia member 13 has an annular protrusion 13a facing the annular portion 11a with an axial distance. The annular protrusion 13a has an axially engine side surface 13b and a radially inner surface 13c.

As seen in FIGS. 5 and 6, the second friction generation mechanism 7 has, in order in an axial direction from the flexible plate 11 toward the axially engine side surface 13b of the inertia member 13, a cone spring 58, a friction plate 59, and friction washers 61. Thus, the flexible plate 11 has a function that accommodates the second friction generation mechanism 7 so the number of components is reduced and the structure simplified. Furthermore, the inertia member 13 has a function that accommodates the second friction generation mechanism 7, thereby increasing the above-mentioned effect.

The cone spring 58 imparts a load in the axial direction to friction surfaces. Further, the cone spring 58 is interposed and compressed between the annular portion 11a and the friction plate 59, and therefore exerts an urging force on both members in the axial direction. Pawls 59a formed on the radially outer edge of the friction plate 59 are engaged with axially extending cutaway areas 11b of the annular portion 11a of the flexible plate 11. Thus, the friction plate 59 is prevented from rotating relative to the flexible plate 11 by this engagement, but is movable in the axial direction.

As seen in FIGS. 4-6, the friction washers 61 are composed of a plurality of members. The members are aligned and disposed in the direction of rotation, and each of these extends in the form of an arc. In this embodiment, there are preferably a total of six friction washers 61. The friction washers 61 are interposed between the friction plate 59 and the axially engine side surface 13b of the inertia member 13. In other words, the axial-direction engine side surface 61a of the friction washers 61 makes contact in a slidable manner with the axial-direction transmission side surface of the flexible plate 11, and the axial-direction transmission side surface 61b of the friction washers 61 makes contact in a slidable manner with the axially engine side surface 13b of the inertia member 13. Referring now to FIGS. 5-7, concavities 62 are formed in the inner circumferential surface of the friction washers 61. The concavities 62 are formed roughly in the center of the direction of rotation of the friction washers 61, and more specifically, have a bottom surface 62a extending in the direction of rotation, and rotational direction end faces 62b extending from both ends thereof in a roughly radial direction (roughly at a right angle from the bottom surface 62a). Each concavity 62 is formed in the axially middle portion of the inner circumferential surface of the friction washer 61 so that the concavity 62 has axial end faces 62d and 62e forming axial side surfaces. In other words, the concavities 62 are formed solely in the intermediate portion in the axial direction of the radially inner surface of the friction washers 61. Roughly disk-like concavities 62c indented on the internal side in the direction of rotation are disposed on the rotational direction end faces 62b. Cushioning members 80 are disposed in these concavities 62c. The cushioning members 80 are members preferably composed of elastic resin or rubber, for example, and are more preferably composed of a thermoplastic polyester elastomer. The main body of the cushioning members 80 is contained within the concavities 62c. A protruding portion of the cushioning members 80 protrudes further inward in the direction of rotation from the concavity 62c, past the rotational direction end face 62b. Further, the outer circumferential surface 61c of the friction washer 61 is in contact with the inner circumferential surface 13c of the inertia member 13c.

A plurality of friction engagement members 63 is radially inward of the friction washers 61 and within the concavities 62. The radially outer portion of the friction engagement member 63 is within the concavity 62. Both the friction washers 61 and friction engagement members 63 are preferably made of resin.

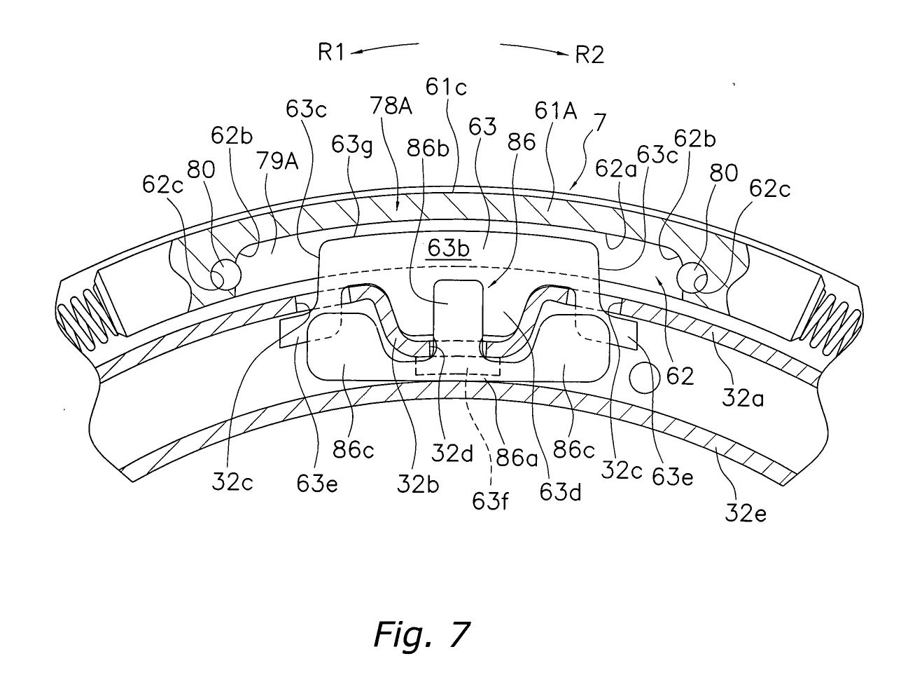

A friction engagement portion 78 including the friction engagement members 63 and the concavities 62 of the friction washer 61 is described below. An outer circumferential surface 63g of the friction engagement member 63 is adjacent to the bottom surface 62a of the concavities 62. The friction engagement members 63 have rotational end faces 63c. Further, a rotational direction gap 79 with a certain angle is defined between each of the rotational end faces 63c and the rotational direction end faces 62b. The total of both angles is a certain angle whose size allows the friction washer 61 thereof to rotate relative to the friction engagement members 63. This angle is preferably within a range that is equal to or slightly exceeds the damper operation angle created by small torsional vibrations caused by combustion fluctuations in the engine. In this embodiment, the friction engagement members 63 are disposed in the center of the direction of rotation of the concavities 62 in the neutral state shown in FIG. 7. Therefore, the size of the gap is the same on either side in the direction of rotation of the friction engagement members 63.

Referring again to FIGS. 5-7, the friction engagement members 63 are engaged with the plates 32 and 33 to rotate together with the first plate 32 and be movable in the axial direction. More specifically, an annular wall 32a extending toward the engine in the axial direction is formed on the radially outer edge of the first plate 32, and concavities 32b indented on the internal side in the radial direction are formed corresponding to each friction engagement member 63 on the annular wall 32a. In addition, slits 32c penetrating in the radial direction on both rotational sides of the concavity 32b and a slit 32d in the concavity 32b are formed.

The friction engagement members 63 have a pair of legs 63e extending through the slits 32c radially inward and bent radially outward contacting the inner circumferential surface of the annular wall 32a. Furthermore, the friction engagement members 63 also have legs 63f that extend extending through the slit 32d radially inward and bent radially outward contacting the inner circumferential surface of the annular wall 32a in both rotational directions which are in contact with the inner circumferential surface of the annular wall 32a. As a result, the friction engagement members 63 do not move outwardly from the annular wall 32a in the radial direction. In addition, the friction engagement members 63 have convexities 63d that extend inward in the radial direction, and are engaged in the direction of rotation with the concavities 32b in the annular wall 32a. The friction engagement members 63 are thereby integrally rotated as convexities of the first plate 32.

The friction engagement member 63 can move in the axial direction relative to the friction washer 61 because the axial length of the friction engagement member 63 is shorter than the axial length of the concavity 62, that is, the distance between the axial end faces 62d and 62e is longer than the axial length of the axial end faces 63a and 63b of the friction engagement member 63. Further, the friction engagement member 63 can also tilt relative to the friction washer 61 to a certain angle because a radial space is ensured between the outer circumferential surface 63g of the friction engagement member 63 and the bottom surface 62a of the concavity 62.

As described above, the friction washer 61 is engaged in a manner that allows torque to be transmitted to the friction engagement members 63 by way of the rotational direction gap 79 in the engagement portion 78. The friction engagement members 63 can also integrally rotate with the first plate 32, and move relatively in the axial direction.

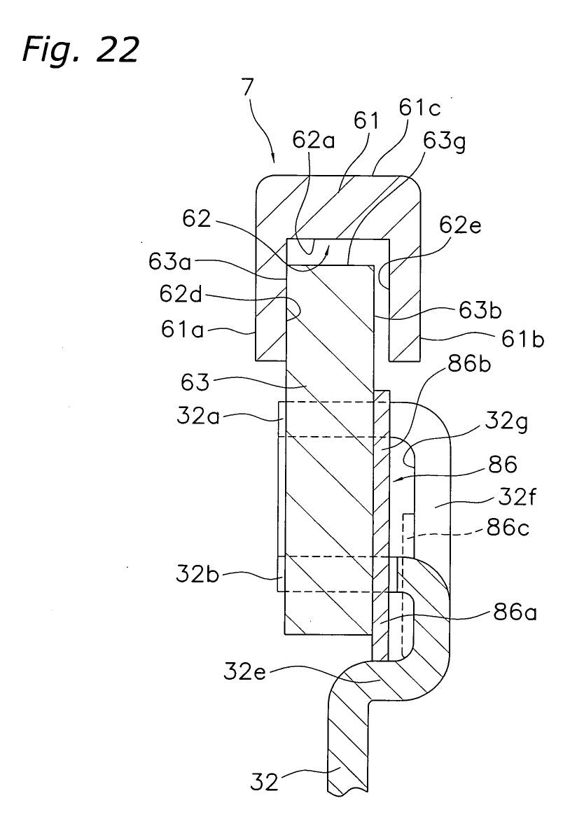

As shown in FIG. 5, a plurality of plate springs 86 is disposed between the friction engagement members 63 and the radially outward portion 32f of the output disk-like plate 32. Each plate spring 86 is disposed corresponding to the friction engagement members 63, as shown in FIG. 7. Referring to FIGS. 5 and 7, the plate spring 86 is composed of a center portion 86a, a first contact portion 86b extending radially outward therefrom, and a pair of second contact portions 86c extending in the rotational direction from the center portion 86a. The first contact portion 86b is in contact with the axially transmission side surface of the friction engagement member 63, and the second contact portion 86c is in contact with an axially engine side surface 32g of the radially outward portion 32f of the output disk-like plate 32. When the clutch is engaged, the plate spring 86 is in a free state or compressed to some extent in the axial direction to urge the friction engagement member 63 toward the engine in the axial direction. When the clutch is released, the second flywheel 3 is moved toward the engine in the axial direction and the output disk-like plate 32 also moves toward the engine in the axial direction, as shown in FIG. 22. As a result, the plate spring 86 starts to be compressed or the compression of the plate spring 86 progresses so that an axial load applied to the friction engagement member 63 is increased. In addition, the radially inner edge of the spring plate 86 is in contact with or adjacent to the radially outer surface of the cylindrical portion 32e extending in the axial direction in the radially inward portion of the radially outward portion 32f of the first plate 32. Accordingly, as shown in FIG. 5, a friction generation unit 72, which produces or increases frictional resistance by clutch release load, is composed of the friction washers 61, the friction engagement members 63, and the plate springs 86.

Next, the relationship between the friction washers 61 and the friction engagement members 63 is described in greater detail. As shown in FIG. 6, the widths in the direction of rotation (the angles in the direction of rotation) of friction engagement members 63 are all the same, but some of the widths in the direction of rotation (the angles in the direction of rotation) of the concavities 62 may be different. That is to say, there are at least three types of friction washers 61 with differing widths in the direction of rotation of the concavities 62. In this embodiment, these are composed of two first friction washers 61A that face each other in the up and down directions of FIG. 6, two second friction washers 61B that are disposed diagonally up and to the right and diagonally down and to the left, and two third friction washers 61C that are disposed diagonally up and to the left and diagonally down and to the right. The first to third friction washers 61A, 61B, and 61C have roughly the same shape, and are preferably made of the same material. The only major point in which these differ is the width in the direction of rotation (the angles in the direction of rotation) of the rotational direction gap of the concavities 62. More specifically, the width in the direction of rotation of the concavities 62 of the second friction washers 61B is greater than the width in the direction of rotation of the concavities 62 of the first friction washers 61A, and the width in the direction of rotation of the concavities 62 of the third friction washers 61C is greater than the width in the direction of rotation of the concavities 62 of the second friction washers 61B. As a result, a second rotational direction gap 79B of a second engagement portion 78B in the second friction washers 61B is larger than a first rotational direction gap 79A of a first engagement portion 78A in the first friction washers 61A, and a third rotational direction gap 79C of a third engagement portion 78C in the third friction washers 61C is larger than the second rotational direction gap 79B of the second engagement portion 78B in the second friction washers 61B. In this embodiment, the angle in the direction of rotation of the first rotational direction gap 79A is preferably 6 degrees, the angle in the direction of rotation of the second rotational direction gap 79B is 12 degrees, and the angle in the direction of rotation of the third rotational direction gap 79C is 18 degrees

The lengths in the direction of rotation (the angles in the direction of rotation) of the first to third friction washers 61A, 61B, and 61C are each different, as in the above-described embodiments and first one is larger than second one, which is larger than the third one. As mentioned before, areas of the first to third friction washers 61A, 61B, and 61C are different and the area in which one operates later is larger than another which operates earlier.

Coil springs 90 are disposed as elastic members between each of the first to third friction washers 61A, 61B, and 61C in the direction of rotation. The coil springs 90 extend in the direction of rotation, and both edges are in contact with the rotational direction edge surface of the friction washers 61. Each coil spring 90 is compressed in the direction of rotation from the neutral state shown in FIG. 6, imparting a load to the friction washers 61 on either side in the direction of rotation.

Here, the coil spring between the first friction washers 61A and the second friction washers 61B is referred to as the first coil spring 90A. Further, the coil spring between the second friction washers 61B and the third friction washers 61C is referred to as the second coil spring 90B. Moreover, the coil spring between the third friction washers 61C and the first friction washers 61A is referred to as the third coil spring 90C. However, the first to third coil springs 90A to 90C have the same shape and same spring constant, and the compressive force in the direction of rotation in the neutral state in FIG. 6 is also the same.

6) Clutch Disk Assembly

The clutch disk assembly 93 has a friction facing 93a disposed adjacent to the first friction surface 3a of the second flywheel 3. Further, the clutch disk assembly has a hub 93b spline-engaged with the transmission input shaft 92.

7) Clutch Cover Assembly

The clutch cover assembly 94 is primarily formed of a clutch cover 96, a diaphragm spring 97, and the pressure plate 98. The clutch cover 96 is an annular disk-like member fixed to the second flywheel 3. The pressure plate 98 is an annular member having a pressing surface adjacent to the friction facing 93a and rotates together with the clutch cover 96. The diaphragm spring 97 is supported by the clutch cover 96 to urge elastically the pressure plate 98 toward the second flywheel 3. When a release device not shown pushes the radially inner end of the diaphragm spring 97 toward the engine, the diaphragm spring 97 releases the load axially placed on the pressure plate 98.

(2) Operation

1) Torque Transmission

Referring to FIGS. 1 and 16, in this double mass flywheel 1, a torque supplied from the crankshaft 91 of the engine is transmitted to the second flywheel 3 via the damper mechanism 4. In the damper mechanism 4, the torque is transmitted through the input disk-like plate 20, coil springs 34-36, and output disk-like plates 32 and 33 in this order. Further, the torque is transmitted from the double mass flywheel 1 to the clutch disk assembly 93 in the clutch engaged state and is finally provided to the input shaft 92.

2) Absorption and Attenuation of Torsional Vibrations

When the double mass flywheel 1 receives combustion variations from the engine, the damper mechanism 4 operates to rotate the input disk-like plate 20 relatively to the output disk-like plates 32 and 33 so that the coil springs 34-36 are compressed in parallel in the rotational direction after all the coil springs 34-36 are engaged. Further, the first friction generation mechanism 5 and the second friction generation mechanism 7 generate a predetermined hysteresis torque. Through the foregoing operations, the torsional vibrations are absorbed and damped.

2-1) Small Torsional Vibrations

The operation of the damper mechanism 4 when small torsional vibrations caused by combustion fluctuations of the engine are inputted to the double mass flywheel 1 is described below.

Referring to FIGS. 1, 7, and 16, when small torsional vibrations are inputted, the output disk-like plate 32 in the frictional resistance generation mechanism 7 rotates relative to the friction washer 61 in the rotational direction gap 79 between the friction engagement members 63 and the concavities 62. In other words, the friction washer 61 is not driven with the friction engagement member 63, and the friction washer 61 therefore does not rotate in relation to the flexible plate 11 and the inertia member 13. As a result, high hysteresis torque is not generated for small torsional vibrations. That is to say, only a hysteresis torque that is much smaller than normal hysteresis torque can be obtained in a prescribed range of torsion angles. Thus, the vibration and noise level can be considerably reduced because a very narrow rotational direction gap is provided in which the second frictional resistance generation mechanism 7 does not operate in the prescribed angle range.

2-2) Wide-Angle Torsional Vibrations

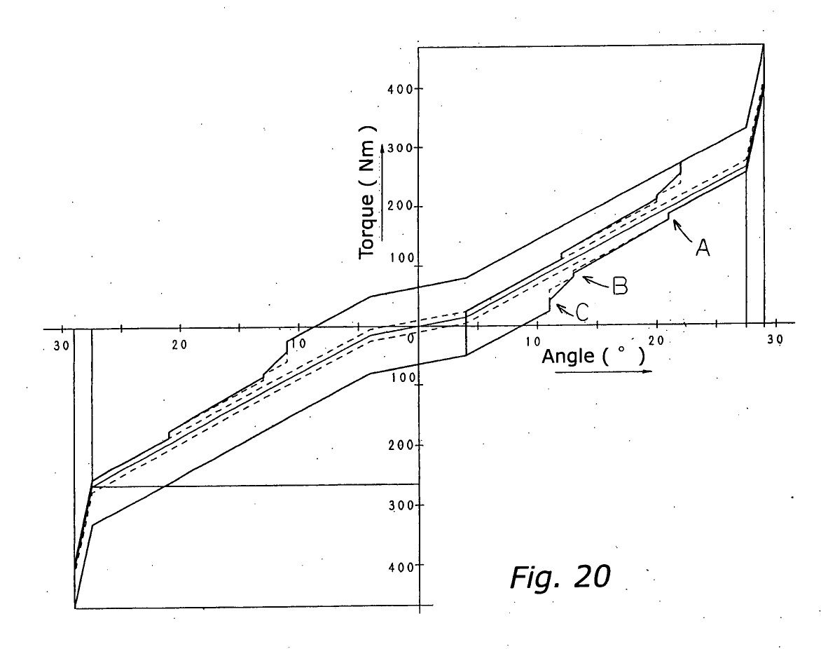

Next, the operation of the damper mechanism 4 is described referring FIG. 16 and to the torsional characteristics of FIG. 20. In a small torsional angle area around zero degrees, only the first coil springs 34 are compressed to achieve relatively low rigidity. As the torsional angle becomes larger, the first coil springs 34 and the second coil spring 35 and the third coil springs 36 are compressed in parallel to achieve relatively high rigidity. The first friction generation mechanism 5 operates over the entire torsional angle range. In the second friction generation mechanism 7, the friction washers 61 slide against the flexible plate 11 and the inertia member 13. As a result, over the entire torsional angle range, a constant frictional resistance is generated. More specifically, in the second friction generation mechanism 7, the friction washers 61 rotates together with the output-side disk plate 32 and rotates relative to the flexible plate 11 and the inertia member 13. As a result, the friction washers 61 slide against both the members to generate relatively high frictional resistance. The second friction generation mechanism 7 does not operate within certain angles on either side of the torsional angle after the direction of the torsional action changes.

Next, the operation performed when the friction washers 61 are driven by the friction engagement members 63 is described. The operation in which the friction engagement members 63 are twisted from the neutral state shown in FIG. 6 toward the friction washers 61 in the rotation direction R1 is described.

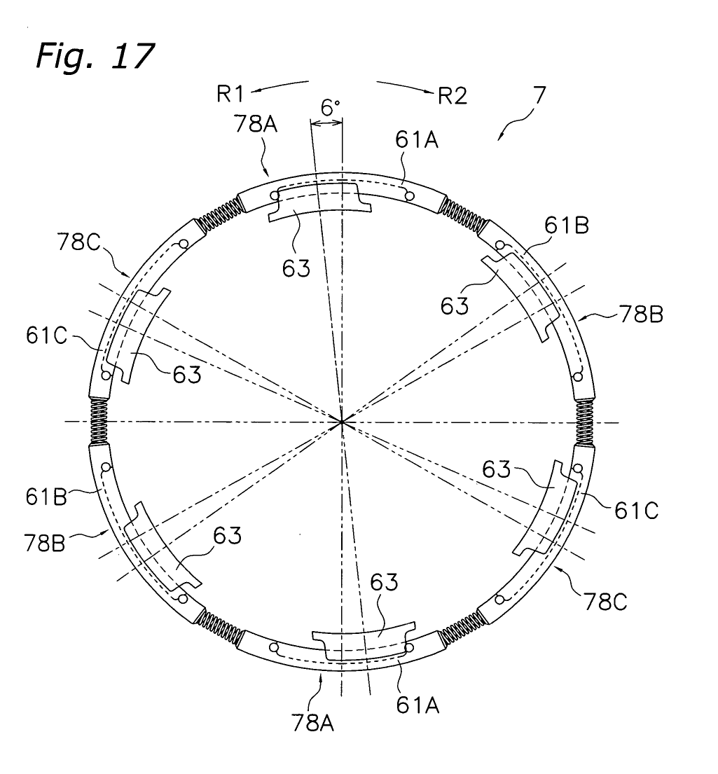

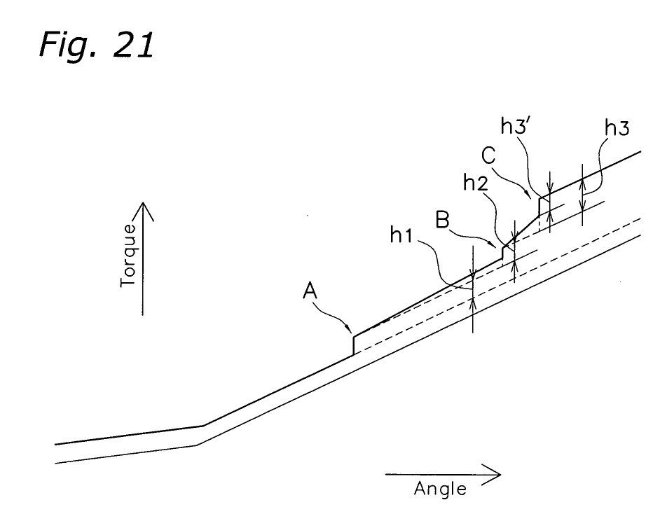

When the torsion angle increases, as shown in FIG. 17, the friction engagement members 63 in the first friction washers 61A eventually make contact with the rotational direction end face 62b of the concavities 62 of the first friction washers 61A in the rotational direction R1. At this time, as shown by the arrow A in FIG. 21, the hysteresis torque h1 builds up.

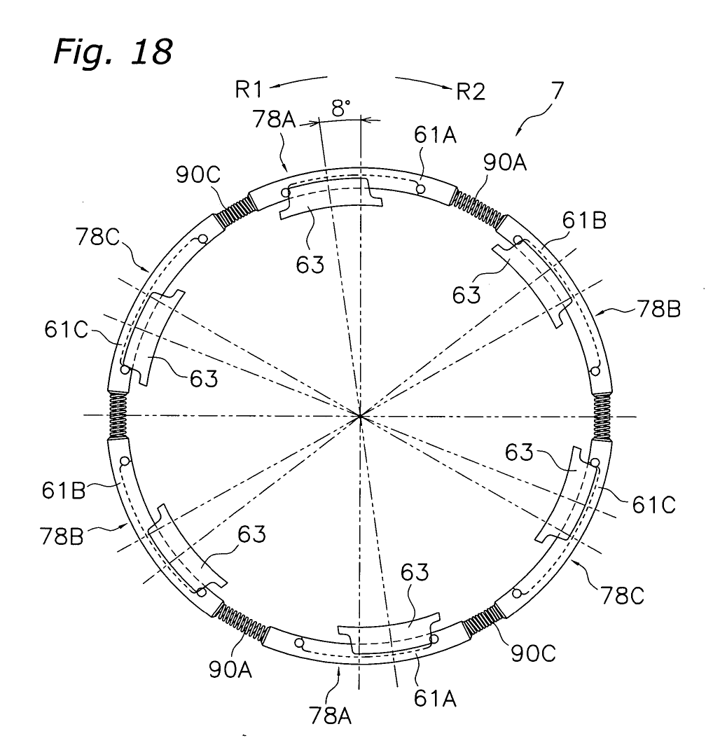

When the torsion angle further increases, the friction engagement members 63 drive the first friction washers 61A, and cause them to slide against the flexible plate 11 and the inertia member 13. During this operation, the third coil spring 90C (the coil spring in the running direction of the first friction washers 61A) is further compressed, and the first coil spring 90A (the coil spring opposite to the running direction of the first friction washers 61A) stretches itself. Therefore, hysteresis torque gradually increases during the operation from FIG. 17 to FIG. 18. The first coil spring 90A in its at most extended state is shorter than its free length. The first coil spring 90A is therefore capable of correctly maintaining its posture and position between the friction washers.

As a result of the above, the second friction washers 61B are configured to move with a small force in comparison with when the coil springs are not present, due to the action of the first to third coil springs 90A to 90C.

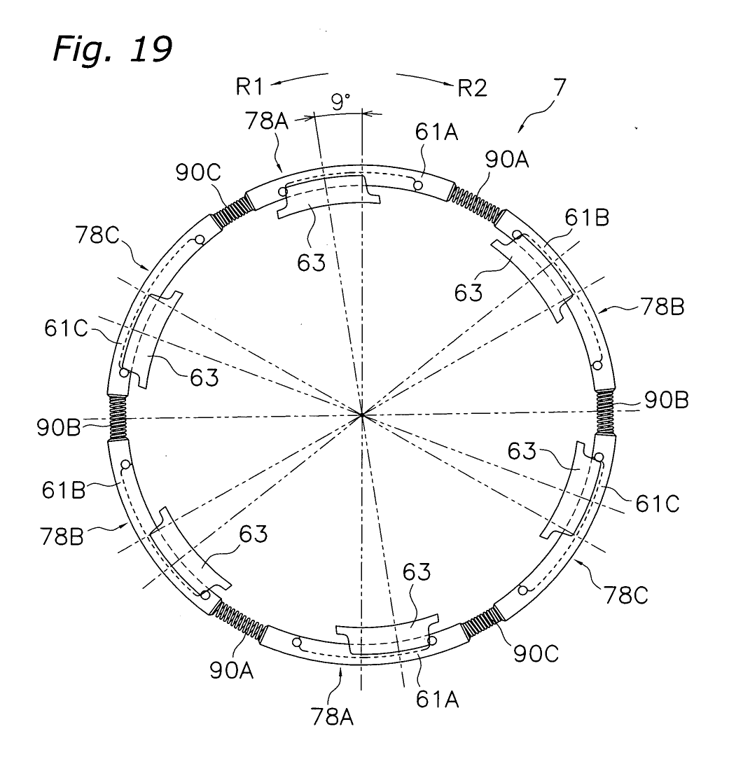

When the torsion angle finally achieves a prescribed magnitude, the friction engagement members 63 make contact with the rotational direction end face 62b of the concavities 62 of the second friction washers 61B, as shown in FIG. 18. At this time, the hysteresis torque h2′ builds up, as shown by the arrow B in FIG. 21. After this, the friction engagement members 63 drive both the first and second friction washers 61A and 61B, causing them to slide against the flexible plate 11 and the inertia member 13. During this operation, the third coil spring 90C (the coil spring in the running direction of the first friction washers 61A) is further compressed, and the second coil spring 90B (the coil spring opposite to the running direction of the second friction washers 61B) stretches itself. Therefore, hysteresis torque gradually increases during the operation from FIG. 18 to FIG. 19. The second coil spring 90B in its at most extended state is shorter than its free length. The second coil spring 90B is therefore capable of correctly maintaining its posture and position between the friction washers.

As a result of the above, the third friction washers 61C are configured to move with a small force in comparison with when the coil springs are not present, due to the action of the first to third coil springs 90A to 90C.

When the torsion angle finally achieves a prescribed magnitude, the friction engagement members 63 make contact with the rotational direction end face 62b of the concavities 62 of the third friction washers 61C, as shown in FIG. 19. At this time, the hysteresis torque h3′ builds up, as shown by the arrow C in FIG. 21. After this, the friction engagement members 63 drive all three of the first to third friction washers 61A, 61B, and 61C, causing them to slide in relation to the flexible plate 11 and the inertia member 13.

In summation, driving the friction washers 61 with the output disk-like plate 32 yields an area in which a constant number of plates are driven to generate an intermediate frictional resistance in the torsion characteristics before the start of the high frictional resistance area in which all of the plates are driven.

A plurality of coil springs 90 is disposed in between the friction washers 61 in the rotational direction in the present invention so, as shown in FIGS. 20 and 21, the hysteresis torque gradually increase at a stage before the second and third friction washers 61B and 61C operate, and, as a result, the buildup hysteresis torques h2′ and h3′ that build up in the vertical direction the instant that the second and third friction washers 61B and 61C operate become respectively smaller than the hysteresis torques h2 and h3 when there are no coil springs. In other words, knocking sounds are reduced when the friction washers are acting.

The above-mentioned effects will be realized by satisfying the following conditions. The lengths in the peripheral direction (surface area) of the first to third friction washers 61A, 61B, and 61C are different, and the surface area increases in order from first to third (in order of later operation). The hysteresis torque of the friction washers is h1<h2<h3, as shown in FIG. 21, and, in particular, the hysteresis torque h3 in the third friction washers 61C has considerably greater magnitude than the hysteresis torques h1 and h2 in the first friction washers 61A and the second friction washers 61B, and the buildup hysteresis torque h3′ when the third friction washers 61A are operating is sufficiently low. The hysteresis torque h1 in the first friction washers 61A is sufficiently low, so there is no particular need to make it lower.

When the rotational direction end face 62b of the friction washers 61 collides with the wall 63c of the friction engagement members 63, the collision is mitigated by cushioning members 80. The knocking noise produced when the friction washers 61 collide with the friction engagement members 63 is therefore reduced and hysteresis torque builds up gradually. Alternatively, the cushioning member may be mounted on the side of friction engagement members 63.

The elastic members disposed between the friction washers in the direction of rotation are not limited to the coil springs 90. Other springs, rubbers, or elastic resins may be disposed therein.

Also, in the above-described embodiment, three types of friction washers are used, but two types, four types or more of friction washers may be used.

2-3) Input of Shock Torque

Referring to FIG. 16, when an excessively large shock torque is input to the double mass flywheel 1, the slip clutch 82 slips, that is, there is no torque transmission between the damper mechanism 4 and the flywheel main body 3A. Consequently, the damper mechanism 4 is unlikely to be destroyed. For example, if the slip clutch 82 is set to operate for a torque that is smaller than the torque capacity of the damper mechanism 4, torque that is greater than the torque capacity is not input to the damper mechanism 4.

Referring now to FIGS. 1 and 16, in this flywheel assembly, the second flywheel 3 is divided into the flywheel main body 3A and the positioning member 3B, and the flywheel main body 3A rotates relative to the damper mechanism 4 and the positioning member 3B when the slip clutch 82 operates. The axially through holes 69a are not displaced from the bolts 22 in the rotational direction, since the positioning member 3B does not rotate together with the flywheel main body 3A. As a result, even if the slip clutch 82 operates, the bolts 22 can be operated without special pre-operation, that is, it is possible to remove the flywheel assembly from the crankshaft 91 easily.

2-4) Operation at the Clutch Release

When the clutch is released, the release load is applied to the second flywheel 3 from the clutch. The load is applied to the positioning member 3B from the flywheel main body 3A, and then applied to the thrust bearing portion 30b of the bush 30. In addition, the output-side disk plates 32 and 33, especially the radially outward portions, move toward the engine in the axial direction. Accordingly, as shown in FIG. 22, an axial distance between the friction engagement member 63 and the axially engine side surface 32g of the first plate 32 is reduced. Consequently, the deflection amount of the plate springs 86 is increased and the force to urge the friction engagement member 63 against the friction washer 61 is increased. As a result, in the friction generation mechanism 7, the axial load applied to friction sliding surfaces by the axial end face 62d and the axial end face 63a compression is generated or increased.

Consequently, when the clutch is released, in a region where the friction generation unit 72 operates, that is, the friction washer 61 and the friction engagement member 63 rotate relative to each other, frictional resistance larger than that at the clutch engagement is generated. By this frictional resistance, if resonance is generated due to the decrease of the engine rotation during a transition from the clutch release state to the clutch engagement state; the resonance is attenuated by the large hysteresis torque.

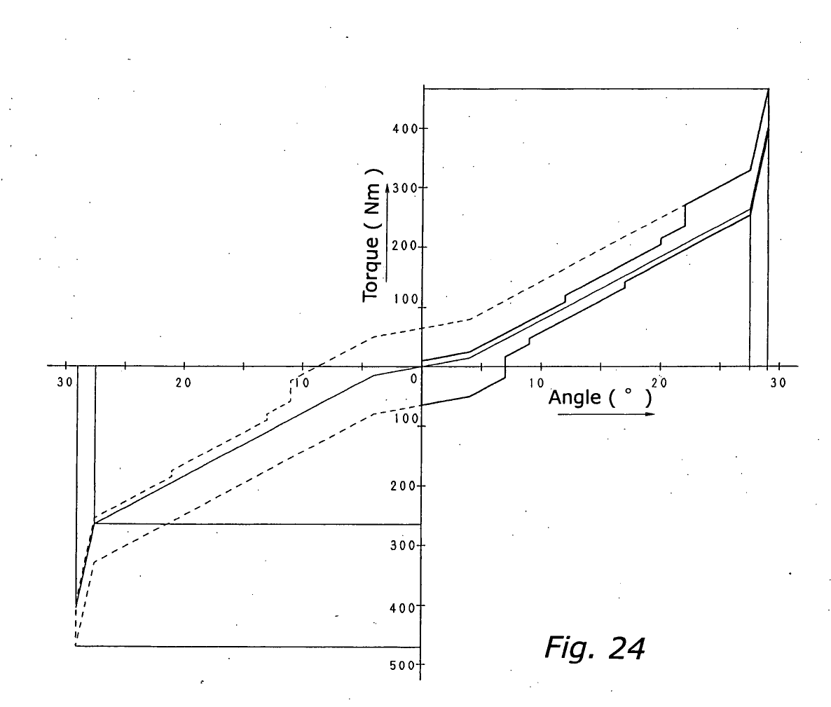

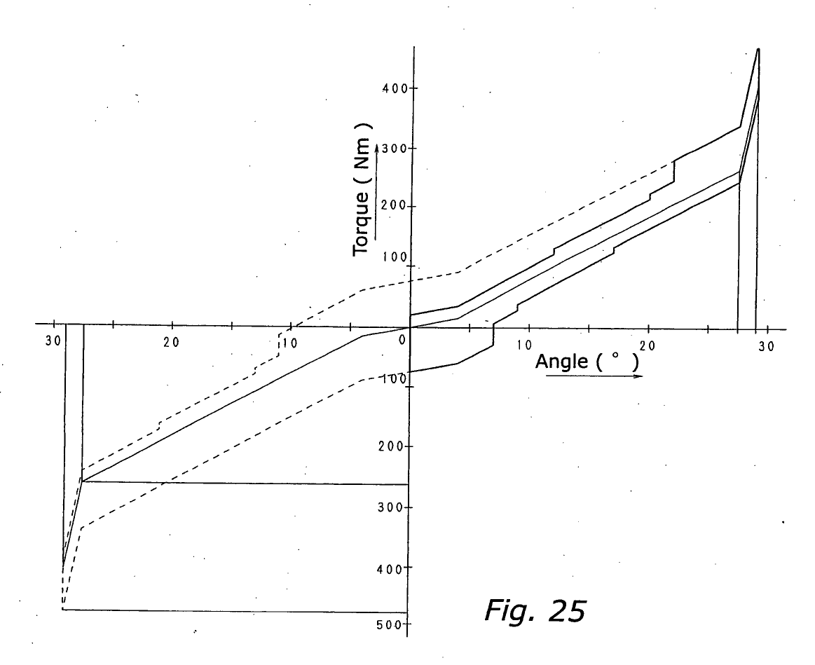

In the other embodiment, the above-mentioned effects will be explained referring to the torsional characteristics diagrams illustrating the characteristics for the second and third preferred embodiments of the present invention. FIG. 24 shows torsional characteristics at the clutch engagement, and FIG. 25 shows torsional characteristics at the clutch release, more precisely, when the clutch starts to be engaged after the clutch release. As apparent from the figures, in the latter one, the hysteresis torque in a range where the friction washer 61 and the friction engagement member 63 slide against each other is larger compared to the former one.

The load applied to the sliding surfaces of two members in the friction generation unit 72 is determined by the plate spring 86 so that it is possible to generate friction appropriate for attenuating the resonance. The load by the plate spring 86 is smaller to large extent than the load for which the clutch release load is utilized.

(3) Advantages

3-1) First Friction Generation Mechanism

Referring now to FIG. 9, the sliding area of the first friction generation mechanism 5 is set relatively large because the first friction generation mechanism 5 makes use of a part of the second flywheel as a friction surface. Specifically, the second friction member 52 is urged against the second flywheel 3, more specifically the positioning member 3B, by the cone spring 53. Accordingly, the pressure per area on the sliding surface is reduced so that the life of the first friction generation mechanism 5 is improved.

As seen in FIG. 8, the radially outer portion of the second friction member 52 and the radially inward portion of the first and second coil springs 34 and 35 overlap in the axial direction. That is to say, the radial position of the outer circumferential edge of the second friction member 52 is radially outward of radial position of the inner circumferential edge of the first and second coil springs 34 and 35. Accordingly, although the second friction member 52 and the first and second coil springs 34 and 35 are very close to each other in the radial direction, it is possible to ensure enough friction area in the first friction generation mechanism 5 and yet conserve space.

The radially outer portion of the annular portion 51a of the first friction member 51 and radially inner portions of the first and second coil springs 34 and 35 overlap when seen in the axial direction, and a radial position of radially outer edges of the annular portion 51a is radially outward of that of radially inner edges of the first and second coil springs 34 and 35. It is possible to ensure large friction surface of the first friction generation mechanism 5 even though the annular portion 51a and the first and second coil springs 34 and 35 are located very closely in the radial direction.

Only the first friction member 51 is unrotatably engaged with the input disk-like plate 20 and the first friction member 51 and the second friction member 52 are unrotatably engaged with each other. Accordingly, it is unnecessary to engage the second friction member 52 with the input disk-like plate 20, thereby making the structure simpler.

The first friction member 51 is composed of the annular portion 51a and is in contact with the first plate 32 to slide in the rotational direction, and a plurality of the engagement portions 51b and 51c extending from the annular portion 51a and engaging with the input disk-like plate 20 to move relatively in the axial direction but not in the rotational direction. The second friction members 52 are formed with a plurality of recesses 52a with which the engagement portions 51b and 51c are engaged to move in the axial direction but not in the rotational direction. Accordingly, it is possible to realize a structure in which the annular portion 51a of the first friction member 51 and the second friction member 52 are disposed apart from each other in the axial direction because the first friction member 51 has the engagement portions 51b and 51c axially that extend.

The cone spring 53 is disposed between the second friction member 52 and the engagement portions 51b and 51c of the first friction member 51 and urges both the members in the axial direction, thereby making the structure simpler.

The washer 54 is seated on the tip of the engagement portions 51b and 51c of the first friction member 51 and receives the load from the cone spring 53. The washer 54 provides the axial load applied to the friction sliding surface stable so that the frictional resistance generated on the sliding surface becomes stable.

The first friction generation mechanism 5 is disposed radially inward of the clutch friction surface 3a of the second flywheel 3, apart from each other. Accordingly, the first friction generation mechanism 5 is unlikely to be affected by the heat from the clutch friction surface 3a, thereby stabilizing frictional resistance.

The first friction generation mechanism 5 is disposed radially inward of the radial center of the first and second coil springs 35 and radially outward of the radially outermost edge of the bolts 22, thereby ensuring a structure with a small space.

3-2) Second Friction Generation Mechanism 7

As see in FIGS. 5 and 22, the second friction generation mechanism 7 is unlikely to be affected by the heat from the clutch friction surface 3a of the second flywheel 3 and has stable characteristics because the second friction generation mechanism 7 is held by the first flywheel 2, more specifically the flexible plate 11 and the inertia member 13. In particular, the first flywheel 2 is unlikely to receive heat from the second flywheel 3 because the first flywheel 2 is connected to the second flywheel 3 by way of the coil springs 34-36.

The second friction generation mechanism 7 makes use of the annular portion 11a of the flexible plate 11 as a friction surface so that the number of components of the second friction generation mechanism 7 is reduced and the structure simplified.

The second friction generation mechanism 7 is disposed radially outward of the clutch friction surface 3a and apart from each other in the radial direction so that the second friction generation mechanism 7 is unlikely to be affected by the heat from the clutch friction surface 3a.

3-3) Flexible Flywheel (First flywheel 2 and Damper Mechanism 4)

As seen in FIGS. 1 and 2, the first flywheel 2 is composed of the inertia member 13 and the flexible plate 11 to connect the inertia member 13 to the crankshaft 91, and is elastically deformable in the bending direction of the crankshaft 91. The damper mechanism 4 is composed of the input disk-like plate 20 to which the torque is inputted from the crankshaft 91, the output disk-like plates 32 and 33 disposed rotatable relative to the input disk-like plate 20, and the coil springs 34-36 to be compressed in the rotational direction by the relative rotation of both the members. The first flywheel 2 can move in the bending direction within a limit relative to the damper mechanism 4. A combination of the first flywheel 2 and the damper mechanism 4 constitute a flexible flywheel.

When the bending vibrations are inputted to the first flywheel 2, the flexible plate 11 deforms in the bending direction, i.e., axially, to absorb the bending vibrations from the engine. In this flexible flywheel, the bending vibration absorption effect by the flexible plate 11 is very high because the first flywheel 2 can move in the bending direction relative to the damper mechanism 4.

The flexible flywheel further includes the second friction generation mechanism 7. The second friction generation mechanism 7 is disposed between the first flywheel 2 and output disk-like plate 32 of the damper mechanism 4, and operate in parallel with the coil springs 34-36 in the rotational direction. The second friction generation mechanism 7 has the friction washers 61 and the friction engagement members 63, which are engaged with each other so as not only to transmit the torque but also to move in the bending direction relative to each other. In this flexible flywheel, the first flywheel 2 can move relative to the damper mechanism 4 in the bending direction within a limit even though they are engaged with each other by way of the second friction generation mechanism 7 because two members are engaged with each other to move relatively in the bending direction. As a result, the bending vibration absorption effect by the flexible plate 11 is very high.

3-4) Third Coil Spring 36

The third coil springs 36 starts operation in the area where torsional angle becomes large to apply adequate stopper torque to the damper mechanism 4. The third coil springs 36 are functionally disposed in parallel to the first and second coil springs 34 and 35 in the rotational direction.

The third coil spring 36 has wire diameter and coil diameter smaller than those of the first and second coil springs 34 and 35 respectively, preferably almost half of those, thereby making the axial space of them smaller. As shown in FIG. 1, the third coil springs 36 are disposed radially outward of the first and second coil springs 34 and 35 and corresponds to the clutch friction surface 3a of the second flywheel 3. In other words, the radial position of the third coil springs 36 is within an annular area defined by the inner circumferential edge and the outer circumferential edge of the clutch friction surface 3a.

In this embodiment, providing the third coil springs 36 improves the capability by raising the stopper torque and realizes a small space for the third coil springs 36 by the dimension and location of the third coil springs 36. Although the third coil springs 36 are disposed at a place corresponding to the clutch friction surface 3a of the second flywheel where the axial thickness is the largest in the second flywheel 3, the axial length of the area where third coil spring 36 is disposed is relatively small, and, in fact, is smaller than the area where the first and second coil springs 34 and 35 are disposed.

In addition, the radial position of the stopper mechanism composed of the projections 20c of the input disk-like plate 20 and the contact portions 43 and 44 of the output disk-like plates 32 and 33 is disposed at the same radial position with the third coil springs 36. Therefore, the radial dimension of the whole structure becomes smaller compared to the structure where the members are located at different radial positions.

### ALTERNATE EMBODIMENTS

Alternate embodiments will now be explained. In view of the similarity between the first and alternate embodiments, the parts of the alternate embodiments that are identical to the parts of the first embodiment will be given the same reference numerals as the parts of the first embodiment. Moreover, the descriptions of the parts of the alternate embodiment that are identical to the parts of the first embodiment may be omitted for the sake of brevity.

### Second and Third Embodiments

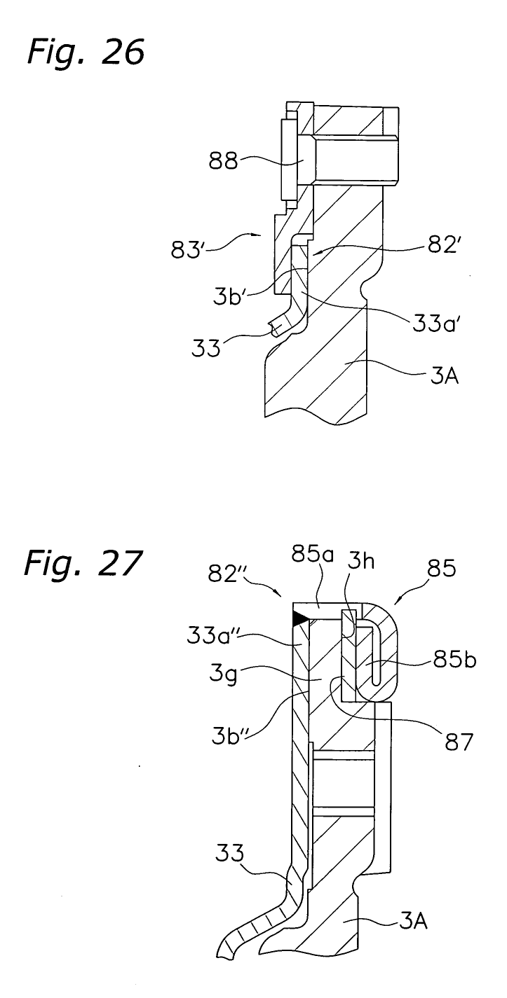

FIGS. 26 and 27 are cross-sectional schematic views of slip clutches 82′ and 82″ of a dual mass flywheel assembly in accordance with second and third preferred embodiments of the present invention, whose structures differ from the first embodiment mainly as described below. As shown in FIG. 26, an elastic plate 83′ is fixed to the flywheel main body 3A through a plurality of bolts 88. As shown, the elastic plate 83′ holds the second plate 33 against a friction facing 3b′ of the flywheel main body 3A. The cross-section of the elastic plate 83′ has sharper angles than that of the first embodiment. Thus, a greater portion of the second plate 33 contacts the elastic plate 83′ than in the first embodiment thereby increasing the operation torque of the slip clutch 82′. Furthermore, as shown in FIG. 27, the slip clutch 82″ is composed of a contact portion 33a′, an elastic plate 85 and a friction plate 87. In this case, the contact portion 33a″ extends to the radially outer edge of the flywheel main body and to which the axial engine side end of the elastic plate 85 is fixed by welding. The elastic plate 85 has a cylindrical portion 85a extending along the radially outer surface of the flywheel main body 3A, and an elastic bending portion 85b extending radially inward from the axial engine side end of the cylindrical portion 85a and then bent radially outward. The friction plate 87 is disposed between a third friction surface 3h on the axial transmission side of the radially outward portion of the flywheel main body 3A and the elastic bending portion. The friction plate 87 is engaged with the cylindrical portion 85a of the elastic plate 85 such that the friction plate 87 can move in the axial direction but not in the rotational direction relative to the cylindrical portion 85a. In this embodiment, two friction surfaces are ensured, namely, between the contact portion 33a″ and the second friction surface 3b′, and between the friction plate 87 and the third friction surface 3h. In other words, a member which rotates together with the second plate 33 is in contact with the axially both surfaces of the flywheel main body 3A, thereby increasing the operation torque of the slip clutch 82″.

(4) Other Embodiments

Embodiments of the double mass flywheel in accordance with the present invention were described above, but the present invention is not limited to those embodiments. Other variations or modifications that do not depart from the scope of the present invention are possible. More particularly, the present invention is not limited by the specific numerical values of angles and the like described above.

Variations of the second friction generation mechanism will be explained.

a) The coefficients of friction of each type of friction members are the same in the above-described embodiment, but these may also be varied. Thus, the ratio of the intermediate frictional resistance and large frictional resistance can be suitably set by adjusting the frictional resistance generated by the first friction member and the second friction member.

b) In the above-described embodiments, the intermediate frictional resistance is generated by providing the friction engagement member with an equal size and concavities with different sizes, but the concavities may be set to an equal size and the size of the friction engagement member may be different. Furthermore, combinations of the friction engagement members and concavities with different sizes may also be used.

c) In the above-described embodiment, the concavity of the friction washer faces the internal side in the radial direction, but it may face the external side in the radial direction.

d) In addition, the friction washer in the above-described embodiment has concavities, but the friction washer may also have convexities. In this case, the input side disk-like plate has concavities, for example.

e) Furthermore, the friction washer in the above-described embodiment has a friction surface that is frictionally engaged with an input member, but it may also have a friction surface that is frictionally engaged with an output member. In this case, an engagement portion having a rotational direction gap is formed between the friction washer and an input side member.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-017472. The entire disclosure of Japanese Patent Application No. 2004-017472 is hereby incorporated by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A flywheel assembly comprising:
a flywheel being configured to have a torque inputted from a crankshaft of an engine;
a damper mechanism being configured to connect elastically said flywheel to said crankshaft in a rotational direction; and
a slip clutch being configured to transmit torque from said damper mechanism to said flywheel, said slip clutch being configured to slip in response to torque exceeding a predetermined value.

2. A flywheel assembly according to claim 1, wherein said slip clutch is disposed on a radially outward portion of said flywheel.

3. A flywheel assembly according to claim 2, wherein said slip clutch is disposed radially outward of a clutch friction surface of said flywheel.

4. A flywheel assembly according to claim 1, wherein said slip clutch has a plate portion that is a part of an output member of said damper mechanism, and an elastic member urging said plate portion against said flywheel.

5. A flywheel assembly according to claim 4, wherein said plate portion contacts both axial side surfaces of said flywheel.

6. A flywheel assembly according to claim 4, wherein said elastic member is fixed to said plate member.

7. A flywheel assembly according to claim 6, wherein said plate member has a first plate in contact with an axially engine side of said flywheel, and a second plate engaged with said first plate to move in an axial direction relative to said first plate and not to move in the rotational direction relative to said first plate, said second plate being in contact with an axially opposite surface of said flywheel, and
said elastic member urges said second plate against said axially opposite surface of said flywheel.

8. A flywheel assembly according to claim 4, wherein said elastic member is fixed to said flywheel.

9. A flywheel assembly according to claim 1, further comprising a plurality of fixing members to fix said damper mechanism to said crankshaft arranged in a circumferential direction,
said flywheel has a flywheel main body to which said slip clutch is connected, and a positioning member to position said flywheel main body in a radial direction relative to a member on a crankshaft side, said positioning member being rotatable relative to said flywheel main body, and
said positioning member is formed with a plurality of axially through holes corresponding to said fixing members.

10. A flywheel assembly according to claim 9, wherein said positioning member is engaged with an output member of said damper mechanism to prohibit relative rotation.

11. A flywheel assembly according to claim 10, wherein said positioning member is engaged with said output member to move relatively in the axial direction.

12. A flywheel assembly according to claim 10, further comprising a friction generation mechanism disposed between an input member of said damper mechanism and said positioning member.

13. A flywheel assembly according to claims 9, wherein said positioning member transmits an axial load from said flywheel main body to said member on said crankshaft side.

14. A flywheel assembly according to claim 2, wherein said slip clutch has a plate portion that is a part of an output member of said damper mechanism, and an elastic member urging said plate portion against said flywheel.

15. A flywheel assembly according to claim 3, wherein said slip clutch has a plate portion that is a part of an output member of said damper mechanism, and an elastic member urging said plate portion against said flywheel.

16. A flywheel assembly according to claim 5, wherein said elastic member is fixed to said plate member.

17. A flywheel assembly according to claim 11, further comprising a friction generation mechanism disposed between an input member of said damper mechanism and said positioning member.

18. A flywheel assembly according to claim 10, wherein said positioning member transmits an axial load from said flywheel main body to said member on said crankshaft side.

19. A flywheel assembly according to claim 11, wherein said positioning member transmits an axial load from said flywheel main body to said member on said crankshaft side.

20. A flywheel assembly according to claim 12, wherein said positioning member transmits an axial load from said flywheel main body to said member on said crankshaft side.
